(19) United States
(12) Patent Application Publication
(10) Pub. No.: US 2010/0105830 A1
(43) Pub. Date: Apr. 29, 2010

(54) METHOD FOR PRODUCING OPTICAL FILM, OPTICAL FILM, POLARIZING PLATE AND DISPLAY

(75) Inventor: Tadahiro Kaneko, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/532,574

(22) PCT Filed: Dec. 10, 2007
(86) PCT No.: PCT/JP2007/073779

§ 371 Date: Sep. 22, 2009

(30) Foreign Application Priority Data
Mar. 31, 2007 (JP) 2007-095827

(51) Int. Cl. C08L 1/10; B29D 7/01; G02B 5/30

(52) U.S. Cl. 524/599; 264/1.34

(57) ABSTRACT

A method of manufacturing an optical film by a solution casting method, in which a poor peeling region of a metal support can be eliminated by casting a dope on the surface of the metal support after a surface treatment film is formed on the surface of the metal support by atmospheric pressure plasma treatment or excimer UV treatment. Consequently, limitation on the conditions of film production is reduced and productivity is enhanced. Furthermore, since peeling of the film is enhanced, lateral variation in peeling position is reduced and variation in retardation value is reduced sharply, and thereby an optical film having optical characteristics excellent in transparency and flatness can be manufactured. Consequently, a method for manufacturing an optical film, an optical film, a polarizing plate and a display device which meet the demands of a high quality thin and wide protective film for polarizing plate can be provided.

### TECHNICAL FIELD

The present invention relates to a manufacturing method of an optical film which is applicable to various functional films such as a polarizing plate protective film, a retardation film or a viewing angle enlarging film, employed in a liquid crystal display device (LCD), or an antireflection film employed in a plasma display, as well as relates to an optical film, a polarizing plate, and a display device.

### BACKGROUND

In recent years, liquid crystal display devices have been employed in television sets and oversized monitors due to enhancement of their image quality and high resolution technologies. Specifically, demand for the size increase of these liquid crystal devices and cost reduction via efficient production have increased for materials of liquid crystal displays, and an increase in width of optical films have been desired.

Further, in recent years, to correspond to the rapid increase in liquid crystal TVs, demand for optical films is rapidly increasing, whereby enhancement of their productivity is highly desired. With regard to optical films which are subjected to film formation via a solution casting film forming method, in the case of a thin-film, since it is possible to employ a small amount of solvents to be removed during drying, it is possible to increase the production rate.

Generally, in a solution casting film forming method, in which a resin solution incorporating a thermoplastic resin and an additive (hereinafter referred to as a dope), is cast onto a metal support, composed of a rotating drive system stainless steel looped belt, drum or roller, though slightly changed via the resin type and the poor solvent ratio, there exists a region in which the force to peel the film from the metal support increases to deteriorate peeling, which is about 60% by mass of the mass ratio of the total solvent mass to the solid content of the film.

In such region, it is not possible to smoothly peel the film from the metal support, whereby fairly pronounced fluttering and peeling noise are accompanied. In addition, since, on the film, sharply stepped deformation extending in the lateral direction is generated due to aforesaid fluttering, and during production, it is essential to set conditions other than the above region, whereby the above region has been a constraint for film production.

The above poor peeling region varies depending on types of dope raw materials such as the type of resins, the addition ratio of poor solvents, or the film temperature during peeling, and the above region exists during the solution casting film forming method of almost all film production.

In order that the above poor peeling region is eliminated, for example, when film production conditions are determined on the so-called high residual solvent (the region in which residual solvent amount is higher than the region in which the aforesaid peeling force increases) side of the cast film (hereinafter also referred to as a web), specifically, in a film at a thickness of at most 40 μm of the product, even though the temperature of drying air which is blown to dry the cast film on the metal support, the evaporation rate of methylene chloride as a solvent is greater, resulting in progress of drying, whereby problems occur in which it is impossible to realize high residual solvent peeling conditions.

Consequently, in order to realize the high residual solvent peeling, there is no other way besides an increase in the film production rate. In such a case, problems have occurred in which it is necessary to conduct substantial facility modification such as extension of the post-drying process to enhance the capacity of solvent recovery facilities and to lower the residual solvent amount to the limit.

Consequently, manufacturing conditions of optical films should generally be those on the low residual solvent peeling side. However, when the low residual solvent peeling conditions are realized, the drying of cast film is included in the falling-drying-rate period. As a result, when the drying period on the metal support is not sufficiently elongated, it has not been possible to decrease the residual solvents, whereby problems have occurred in which the manufacturing rate is significantly decreased.

As mentioned above, conventionally, due to the presence of the poor peeling residual solvent region of the metal support, a problem has occurred in which film should be formed at the manufacturing rate which is much lower than the apparatus capability.

Consequently, in order to overcome the aforesaid conventional drawbacks, Patent Documents 1 and 2 disclose manufacturing methods of cellulose acetate film in which auxiliary agents are incorporated in the dope. Further, Patent Document 3 relates to an instrumentally improved method to manufacture optical films and discloses a manufacturing method of cellulose acetate film which is formed by employing a casting metal support at a specific surface roughness (Ra) in a solution casting film forming apparatus. Further, Patent Document 4 relates to an instrumentally improved method to manufacture optical films and describes a manufacturing method in which by arranging continuous spiral grooves on the surface of a metal support, flat and smooth optical film is consistently manufactured over a long period, while maintaining the desired peeling properties and inhibiting accumulation of deposits onto the surface of the metal support.

Further, Patent Document 5 discloses a manufacturing method of thermoplastic resin film, which is characterized by removal of organic substances, adhered to a rotating body by exposing plasma to the rotating body in contact with the transported film. Further, Patent Document 6 discloses a manufacturing method of films characterized in that in a manufacturing method of films while removing adhesives on the surface of a roller by exposing ultraviolet rays onto the surface or rollers, ultraviolet ray exposure is carried out employing an excimer UV lamp which has, at least, a part having no electrode on the ultraviolet ray exposure surface side and the distance between the excimer UV lamp and the roller surface is at most 50 mm.

Patent Document 1: Japanese Patent Application Publication Open to Public Inspection (hereinafter referred to as JP-A) No. 2003-55501

### Patent Document 2: JP-A No. 2003-128838

### Patent Document 3: JP-A No. 2000-239403

### Patent Document 4: JP-A No. 2002-264152

### Patent Document 5: JP-A No. 2001-62911

### Patent Document 6: JP-A No. 2003-89142

### SUMMARY OF THE INVENTION

### Problems to be Solved by the Invention

However, problems have occurred in which the methods described in aforesaid Patent Documents 1 and 2 result in insufficient effects to the aforesaid poor peeling region described above.

Further, the methods described in aforesaid Patent Documents 3 and 4 have also not eliminated the poor peeling region of the web.

In addition, the methods described in aforesaid Patent Documents 5 and 6 make it possible to prevent the formation of abrasion on the film forming surface by removing organic substances adhered to the film forming surface so that the initial state is maintained. However, enhancement of mold releasing properties of the solution cast film has not yet been realized.

When the width of the cast dope on a metal support exceeds 1,700 mm, conventionally, fluctuation of peeling properties in the lateral direction of the film has resulted in variation of the peeling position even in the region beyond the aforesaid poor peeling region of the web. Namely, when peeled from the metal support, stress applied to the web tends to fluctuate across its width. As a result, problems occur in which retardation values fluctuate in both the lateral and longitudinal directions. In a liquid crystal panel which has been subjected to high fineness year after year, the above fluctuation of characteristics of optical films has been a major problem since it results in decreased contrast and forms contrasting density non-uniformity.

An object of the present invention is to solve the aforesaid conventional technical problems so that, in the manufacturing method of an optical film via the solution casting film forming method, by eliminating poor peeling regions of the metal support, limitations for film manufacturing conditions are reduced to increase productivity. Further, another object is to provide an optical film manufacturing method, an optical film, a polarizing plate, and a display device, which are capable of meeting the demand of the decrease in thickness, the increase in width, and the enhancement of quality of the polarizing plate protective films by manufacturing an optical film which exhibits excellent transparency and flatness by enhancing mold releasing properties (peeling properties) from the metal support.

### Means to Solve the Problems

The above objects are achieved by the following structures.

1. A method of manufacturing an optical film comprising the steps of:

casting a resin solution containing a thermoplastic resin and an additive on a surface of a metal support to form a cast film; and

peeling the cast film from the metal support after a part of a solvent is evaporated,

wherein

the method further comprises the step of forming a surface treatment film via an atmospheric pressure plasma treatment or an excimer UV treatment

on an arbitrary zone on a surface of the metal support, before casting the resin solution on the metal support or

on a zone on a surface of the metal support where the cast film is not passed, while casting the resin solution on the metal support,

followed by casting the resin solution on the surface of the metal support.

2. The method of Item 1, wherein the atmospheric pressure plasma treatment or the excimer UV treatment is carried out by applying plasma or UV light on the metal support under existence of at least a vapor of the solvent to form the surface treatment film.

3. The method of Item 1, wherein the atmospheric pressure plasma treatment or the excimer UV treatment is carried out by applying plasma or UV light on the metal support under existence of one of or both of:

a vapor of the solvent; and

a gas used for the atmospheric pressure plasma treatment or the excimer UV treatment, to form the surface treatment film.

4. The method of any one of Items 1 to 3, wherein a contact angle between water and the metal support on which the surface treatment film is formed is 5-40°.

5. The method of any one of Items 1 to 4, wherein the thermoplastic resin is a cellulose ester resin.

6. The method of any one of Items 1 to 5, wherein the metal support is an endless belt, a drum or a roll, each for film formation.

7. The method of any one of Items 1 to 6, wherein a lowest force needed to peel the cast film increases by 0.1-2.0 (N/m) while forming the cast film for 24 hours.

8. An optical film manufactured by the method of any one of Items 1 to 7.

9. The optical film of Item 8, wherein a fluctuation of transmittance of light at a wavelength of 600 nm of the optical film placed in a crossed Nicol state is 2×10⁻⁵ to 60×10⁻⁵ (%).

10. A polarizing plate having the optical film of Item 8 or 9 on at least one surface of the polarizing plate.

11. A display device employing the polarizing plate of Item 10.

### EFFECTS OF THE INVENTION

According to the present invention, in the manufacturing method of optical films via the solution casting film forming method, by casting a dope onto the surface of a metal support, it is possible to eliminate the poor peeling regions of the metal support by casting the dope onto the surface of the metal support after forming a surface treatment film by applying an atmospheric pressure plasma treatment or an excimer UV treatment onto the surface of the metal support. By doing so, limitations of film manufacturing conditions are reduced to enhance productivity. Further, by enhancing film peeling properties, variation of the peeling position in the lateral direction is reduced and fluctuation of retardation values is also significantly reduced, whereby it is possible to manufacture optical film which exhibits excellent optical characteristics in terms of transparency and flatness. Based on the above, it is possible to provide a manufacturing method of optical films, optical films, polarizing plates, and display devices, which is capable of meeting demands such as decreased thickness, increased width, and enhanced quality of polarizing plate protective films.

### BRIEF DESCRIPTION OF THE DRAWINGS

FIG. 1 is a constitutional view showing the first embodiment of an apparatus which conducts the manufacturing method of optical film via the solution casting film forming method in the present invention.

FIG. 2 is a constitutional view showing the second embodiment of an apparatus which conducts the manufacturing method of optical film via the solution casting film forming method in the present invention.

FIG. 3 is an explanatory view describing the principle of an atmospheric pressure plasma apparatus employed in the manufacturing method of optical film in the present embodiment.

FIG. 4 is an explanatory view describing the principle of an excimer UV apparatus employed in the manufacturing method of optical film in the present embodiment.

### DESCRIPTION OF THE NUMERALS

1 dope tank
1a dope (resin solution)
1b web (cast film)
2 solution feeding pump
3 casting die
4 low-pressure chamber
5 drum
6 metal support (drum)
7 metal support (looped belt)
8 peeling roller
9 film
10 drying apparatus
11 drying air flow
12 tenter
13 winding apparatus
20 atmospheric pressure plasma apparatus
30 excimer UV apparatus
100 optical film manufacturing apparatus
200 surface treating apparatus
A film forming and processing zone
a and b electrodes
g reaction gas
d gap between blowing slit and metal support surface
h blowing slit
s metal support
p purging gas
r reflection plate
u excimer UV lamp
d2 gap between quartz glass and metal support surface
q quartz glass

### BEST MODES TO CARRYOUT THE INVENTION

The embodiment of the present invention will now be described with reference to the drawings, however the present invention is not limited thereby.

The method of manufacturing the optical film via the present embodiment is one via a solution casting film forming method. A web is formed by casting a dope containing a thermoplastic resin and an additive onto a metal support. After evaporating a part of a solvent, a process in which the web is peeled from the metal support is included. An atmospheric pressure plasma treatment or an excimer UV treatment is carried out under existence of an organic solvent vapor or a monomer gas on an arbitrary zone on the surface of the metal support, before casting the resin solution on the metal support or, while casting the resin solution on the metal support, on a zone on a surface of the metal support where the cast film is not passed (the zone in which, during film formation, the surface of the metal support is exposed), whereby on the surface of the metal support, a surface treatment film is formed, which exhibits such tendency that it lowers the contact angle of pure water on the surface of the metal support when compared with the contact angle of pure water on the surface of the original metal support, and then, the dope is cast thereon.

According to the method of manufacturing an optical film via the present embodiment, by forming the aforesaid surface treatment film on a surface of the metal support, it has become possible to eliminate the poor peeling residual solvent regions which lower the productivity of a film.

Further, as a side effect, mold releasing properties (peeling properties) of the surface of the metal support are improved, resulting in effects such that white stain on the metal surface, which forms over time, is hardly formed or even when stain is adhered, it is easily removed, whereby no staining phenomena over time have been observed.

With regard to possibility of physical changes of the surface of the metal support, prior to and after exposure of atmospheric plasma or excimer UV to SUS 304 or 316 plate, each of which surface has been subjected to ultra-mirror finish, surface roughness Ra results in no change via determination employing a scanning type atomic force microscope (hereinafter referred to as AFM). Therefore, it is assumed that possibility tends to be low in which peeling properties of the film change due to a roughened surface of a metallic body, or on the contrary, a smoothened surface of a metallic body.

On the other hand, with regard to chemical changes of the surface of a metallic body, in determining the contact angle of pure water on the surface, which exhibits about 70° prior to treatments, decreases to about 10°. Further, even though the contact angle decreases, a difference is noted between the case in which atmospheric pressure plasma or excimer UV is applied in the presence of an organic solvent vapor or a monomer gas, and the case in which the application is carried out only in an air ambience. In the former, peeling properties of the film are enhanced (a decrease in peeling force), while in the latter, peeling properties result in no significant change. Further, an increase in carbon atoms on the surface of the metal support after the treatment is observed via XPS (X-ray photoelectron spectroscopy), compared to the surface prior to the processing. Though, at this time, the mechanism is not sufficiently understood, it is assumed to be as follows. A treatment film such as monolayer amorphous hydrocarbon formed from an organic solvent vapor or a monomer gas, which decreases the pure water contact angle is formed to lower peeling force of the cast film, whereby, when an optical thin-film is peeled from the metal support at a high rate, it is possible to reduce peeling stress applied to the film, and fluctuation of optical characteristics is decreased. In practice, it has become possible to decrease the fluctuation range of the crossed Nicol transmittance (CNT) of the optical film.

Heretofore, it has been known that via exposure to atmospheric pressure plasma or excimer UV, surface cleaning properties are improved. This time, it has been newly discovered that by positively forming a surface treatment film, “peeling properties” are significantly improved.

As noted above, according to the film manufacturing method via the present embodiment, by eliminating so-called poor peeling regions of the metal support, conventional limits for film manufacturing conditions are reduced, and the selectable range of the film manufacturing conditions is significantly broadened. At the same time, mold releasing properties (peeling properties) of film from the metal support are improved. As a result, highly smooth peeling properties are realized over the entire peeling residual solvent region, and fluctuation of the peeling position in the lateral direction is reduced and fluctuation of crossed Nicol transmittance is significantly decreased, whereby it is possible to manufacture an optical film exhibiting optical characteristics of excellent transparency and flatness.

The manufacturing method of an optical film via the present embodiment will now be detailed. It is possible to prepare the optical film via a solution casting film forming method.

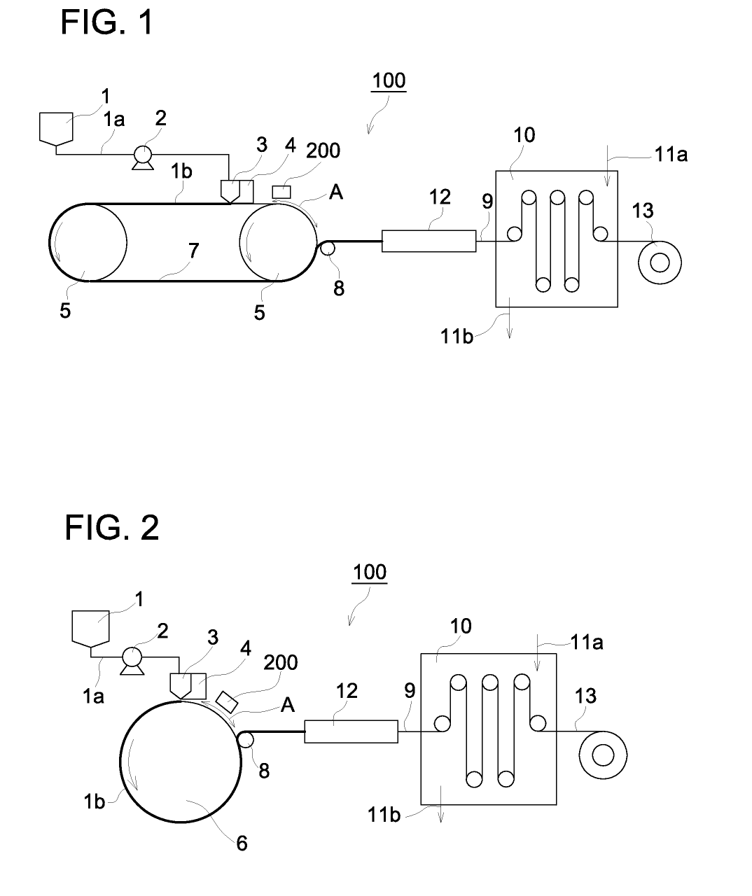

FIG. 1 is a constitutional view showing the first embodiment of optical film manufacturing apparatus (100) which practices an optical film manufacturing method via the solution casting film forming method in the present invention. In the present first embodiment, a case is exemplified in which a looped belt is employed as a metal support. The present embodiment is not limited to the constitution depicted in the following drawings.

Initially, in FIG. 1, dissolved in dope tank (1) are, for example, cellulose ester based resins in a mixed solvent of good solvents and poor solvents, followed by incorporation of additives such as plasticizers and UV absorbers, whereby a dope is prepared.

Subsequently, the dope prepared in the dope tank is transported to casting die (3) via a pipe through solution feeding pump (2). Dope (1a) is cast from casting die (3) onto the casting position of metal support (7) composed, for example, of a rotary drive type looped metal support.

Casting of dope (1a) via casting die (3) is carried out via a doctor blade method which regulates the film thickness of cast web (1b) via a blade, or a method via a reverse roller coater in which the thickness is regulated via a reversely rotating roller. It is preferable to employ a method utilizing a pressure die, in which it is possible to regulate the slit shape at the base portion and to easily achieve uniform film thickness. Pressure dies include a coat hanger die and a T die, and any of these are preferably employed. In casting die (3), pressure reducing chamber (4) is commonly arranged.

The solid concentration of dope (1a) is preferably 15-30% by mass. When the solid concentration of dope (1a) is less than 15% by mass, it is not possible to achieve sufficient drying on metal support (7) and some of web (1b) remain on metal support (7), resulting in belt staining which is not preferred. Further, when the solid concentration of dope (1a) exceeds 30%, dope viscosity increases, resulting in earlier filter clogging and no casting onto metal support (7) due to an increase in pressure during casting.

In illustrated optical film manufacturing apparatus (100) provided with a rotary drive type looped belt as metal support (7), metal support (7) is held via a pair of front and rear drums (5) and (5) and a plurality of intermediate rollers (not shown).

A drive apparatus (not shown) which applies tension to metal support (7) is arranged on one or both sides of drums (5) and (5) of winding portion of metal support (7), composed of a rotary drive type looped belt. Thus, tension is applied to metal support (7), whereby it is employed in a strained state.

It is preferable that the width of metal support (7) is 1,700-2,400 mm, the cast width of dope (1a) is 1,600-2,500 mm, and the width of film (9) after winding is 1,400-2,500 mm. By doing so, via the film forming method employing metal support (7), it is possible to manufacture optical films for wider liquid crystal display devices.

Further, the transport rate of metal support (7) is preferably 40-200 m/minute.

When a rotary drive type looped belt is employed as metal support (7), the belt temperature during the formation of film is commonly in the temperature range of 0° C. to less than the boiling point of the solvent, or when a mixed solvent is employed, less than the boiling point of the solvent exhibiting the lowest boiling point. The temperature range is more preferably 5° C. to boiling point of the solvent −5° C. At this time, it is necessary to control the ambient humidity at a dew point or higher.

Web (1b) which has been cast onto the surface of metal support (7), as described above, is subjected to accelerated drying during the period until peeling, allowing for increased strength.

In the system in which a rotary drive type looped belt is employed as metal support (7), web (1b) dries and solidifies on metal support (7) until web (1b) exhibits film strength so that web (1b) can be peeled from metal support (7) via peeling roller (8). Accordingly, it is preferable to carry out drying so that the residual solvent mass in web (1b) reaches at most 150% by mass, and it is more preferable to carry out drying so that the residual solvent mass reaches 80-120% by mass. Further, the web temperature when web (1b) is peeled from metal support (7) is preferably 0-30° C. Further, immediately after peeling web (1b) from metal support (7) the temperature once rapidly decreases due to evaporation of solvents from the surface side in close contact with metal support (7), whereby ambient water vapor and volatile components such as solvent vapor tend to condense, for which reason the web temperature during peeling is more preferably 5-30° C.

The residual solvent ratio of web (1b), as described herein, is represented by the following formula:

Residual solvent ratio (in % by mass)={(M−N)/N}×100

wherein M is the mass at an arbitrary point of web (1b), and N is the mass of the material when the material at a mass of M is subjected to 110° C. for 3 hours.

Web (1b) formed via dope (1a) cast onto metal support (7) is heated on metal support (7), and solvents are evaporated until web (1b) can be peeled from metal support (7) via peeling roller (8).

Solvent evaporation is carried out via a method in which air is blown from the web (1b) side, a method in which heat is transmitted via liquid from the reverse side of metal support (7), or a method in which heat is transmitted from both the front surface and the rear surfaces. These methods may be employed individually or in combination as appropriate.

In a system in which the rotary drive type looped belt is employed as metal support (7), peeling tension during peeling web (1b) from metal support (7) via peeling roller (8) is greater than the peeling force obtained by determination of the peeling force such as JIS Z 0237. The reason is as follows. When, during high rate film formation, the peeling tension is regulated to be the same as the peeling force obtained by the JIS determination method, the peeling position occasionally shifts downstream. Therefore, to achieve stabilization, higher peeling tension is employed. It is also confirmed that even when films are formed via processes, each exhibiting the same peeling tension, fluctuation of crossed Nicol transmittance (CNT) is significantly reduced when the peeling force determined via the JIS determination method is decreased.

In the process, peeling is carried out commonly in the range of 50 N/m-250 N/m in terms of peeling tension value. In a thinner optical film than conventional one, which is prepared via the present embodiment, web (1b) incorporates a large amount of solvents during peeling, and tends to elongate in the conveying direction, whereby the film tends to shrink in the lateral direction. When combined with drying and shrinkage, the edge curls and breaks back, whereby wrinkles tend to be introduced. Therefore, it is preferable to carry out peeling in the range of the lowest tension which makes it possible to achieve peeling at about 170 N/m, while it is more preferable to carry out peeling in the range of the lowest tension of about 140 N/m.

In the present embodiment, web (1b) is dried and solidified on metal support (7) until it achieves film strength capable of peeling. Thereafter, web (1b) is peeled via peeling roller (8). Subsequently, in tenter (12) of the stretching process described below, web (1b) is stretched, whereby film (9) is manufactured.

FIG. 2 is a constitutional view showing the second embodiment of optical film manufacturing apparatus (100) which practices the optical film manufacturing method via the solution casting film forming method in the present invention. In the present second embodiment, a case is exemplified in which as metal support (6), a rotary drive type stainless steel drum is employed which has been subjected to, for example, hard chromium plating on its surface.

Further, since the other points of optical film manufacturing apparatus (100) are identical to optical film manufacturing apparatus (100) in above FIG. 1, in FIG. 2, the same ones are represented by the same symbol and descriptions are abbreviated.

In the optical film manufacturing method of the first and second embodiments, prior to casting dope (1a) onto the surface of metal support (6) or (7), in an arbitrary zone of the surface of the metal support or a zone (during film formation, a zone in which the surface of metal support (6) or (7) is exposed) in which web (1b) on the surface of the metal support is not passed during film formation, a surface processed film is formed on the surface of metal support (6) or (7) via the atmospheric pressure plasma treatment or excimer UV treatment in the presence of organic solvent vapor or a monomer gas, and dope (1a) is cast onto the resulting surface.

During film formation by casting dope (1a) onto metal support (6) or (7), formation of surface treatment film, which is subjected to an atmospheric pressure treatment or an excimer UV treatment, is carried out in the zone represented by symbol “A” in FIGS. 1 and 2. Namely, web (1b) is peeled from metal support (6) or (7) via peeling roller (8), and thereafter, repeatedly casting dope (1a) from casting die (3) is limited to the zone where the surface of metal support (6) or (7) is exposed.

As an example of surface treating apparatus (200) which forms a surface treatment film in the first and second embodiments, atmospheric pressure plasma apparatus (20) employed in the atmospheric pressure plasma treatment, will now be detailed.

In atmospheric pressure plasma apparatus (20) of the present embodiment, by resulting in discharge via application of high frequency voltage between facing electrodes, reactive gases are subjected to a plasma state. By exposing the surface of the metal support to the reactive gases in the resulting plasma state, a surface treatment film to enhance mold releasing properties is formed on the surface of the metal support.

In the atmospheric pressure plasma apparatus, employed are a system called a direct system or a planar system in which fed gases are resulted in a plasma state via application of high frequency electric power between facing electrodes while interposing the substrate to be treated, and a system called a remote system or a downstream system in which reactive gases are introduced through a gap between electrodes to which high frequency voltage is applied so that the gases result in a plasma state. It is possible to employ either of these in the present invention. However, in the manufacturing method of optical films of the present embodiment, to form a surface treatment film on metal support (6) or (7), it is more preferable to employ the latter system, called the remote system or the downstream system.

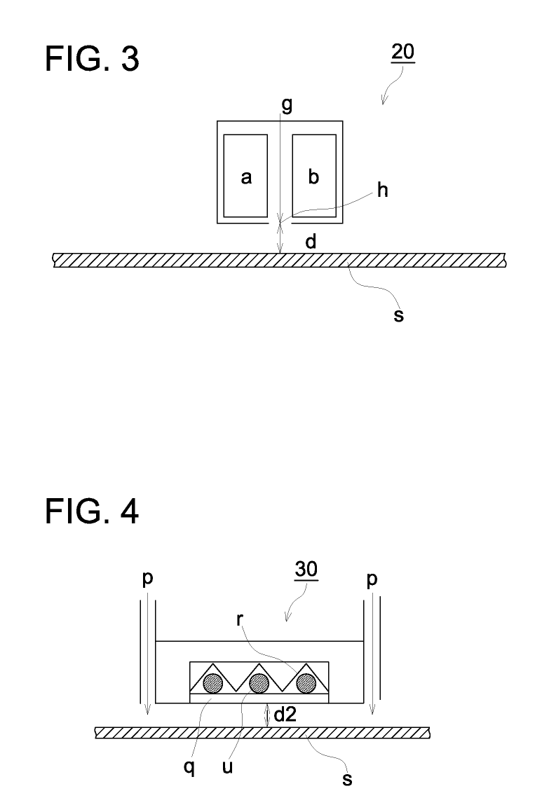

FIG. 3 is a view to describe the principle of atmospheric pressure plasma apparatus (20).

In FIG. 3, (a) and (b) are counter electrodes of atmospheric pressure plasma apparatus (20); (g) is reactive gas; (d) is the gap between blowing slit (h) which ejects and feeds plasma and the surface of metal support (s); (s) is a metal support for film formation; and (h) is a blowing slit which ejects and feeds plasma.

With regard to a simple structure of the atmospheric pressure plasma apparatus in FIG. 3, reactive gas (g) is introduced between counter electrodes (a) and (b) to which high frequency voltage is applied and is subjected to a plasma state. The resulting plasma is ejected and fed onto the surface of metal support (s), whereby a surface treatment film is formed.

In the present embodiment, it is necessary to employ, in atmospheric pressure plasma apparatus (20), electrodes (a) and (b) which can maintain a uniform glow discharge state via application of high power voltage.

As above electrodes (a) and (b), preferred are those in which dielectrics are applied onto a metallic base material. It is preferable that at least one of the facing applied electrodes and the grounding electrode is covered with dielectrics, while it is more preferable that both of the facing applied electrodes and the grounding electrode are covered with dielectrics. As dielectrics, preferred are inorganic materials at a dielectric constant of 6-45. Listed as such dielectrics are ceramics such as alumina or silicon nitride, and glass lining materials such as silicate based glass or borate based glass.

Further, when a cellulose ester film, which is a transparent film substrate, is arranged between electrodes or is exposed to plasma by conveying it between electrodes, the following is preferred. The roller electrode is prepared which can be conveyed while a transparent film substrate is brought into contact with one of the electrodes. In addition, the dielectric surface is highly polished so that the surface roughness of Rmax (JIS B 0601) of the electrode reaches at most 10 μm, whereby it is possible to maintain the thickness of the dielectric and the gap between electrodes, to stabilize the discharge state, and further to minimize distortion and cracking due to thermal contraction difference and residual stress. Further, by covering inorganic dielectrics which are not porous and highly accurate, it is possible to significantly enhance durability.

Further, gap (d) between blowing slit (h) which ejects and feeds plasma and the surface of metal support (s) is preferably 0.5-6 mm, but is more preferably 1-4 mm. When the gap is excessively small, direct contact with the surface of metal support (s) may result in damage, while when the gap is excessively large, effects of formation of the surface treatment film deteriorate.

Further, as reactive gases, it is possible to employ various ones such as nitrogen, oxygen, or helium. However, in view of environmental aspects, post-treatments of emission, and running cost, nitrogen is preferred and nitrogen incorporating a minute amount of oxygen is more preferred. The mixing ratio of oxygen is preferably at most 2% by volume with respect to the volume of the reactive gas (g).

Still further, as raw material gases for forming the surface treatment film, organic solvent vapor such as methylene chloride or alcohols, or monomer gases such as acetylene, are mixed with nitrogen and oxygen, and the resulting mixture may be introduced as aforesaid atmospheric pressure plasma reactive gas (g). The mixing ratio is preferably in the range of 0.2-20% by volume with respect to the total volume of nitrogen and oxygen.

When raw material gases for forming the surface treatment film are not mixed with atmospheric plasma reactive gas (g), film formation may be carried out in such a manner that the aforesaid raw material gases are blown onto the surface of metal support (s) from the exterior of atmospheric plasma apparatus (20) and conveyed below atmospheric pressure plasma apparatus (20) while accompanied with the surface of metal support (s), followed by reaction and film formation.

In the above case, the concentration of raw material gases around atmospheric pressure plasma apparatus (20) is preferably in the range of 500 ppm-100,000 ppm, but is more preferably in the range of 1,000 ppm-50,000 ppm.

Further, the flow rate of atmospheric pressure plasma raw material gases is preferably 2×10⁻²-5 m³/minute per meter of the effective width of plasma exposure, but is more preferably 4×10⁻²-2.5 m³/minute.

Still further, in atmospheric pressure plasma apparatus (20), it is a concern that damage such as formation of roughness on the surface of metal support (s), due to induction current or electric discharge, occurs. Therefore, it is desirable to employ an apparatus incorporating shielding mechanisms. Specifically, when film is formed via the solution casting film forming method, all abrasion of mm order on the surface of metal support (s) are transferred to the film. Therefore, it is critical to employ an apparatus which is subjected to the above countermeasure.

In the first and second embodiments, as an example of surface treating apparatus (200), excimer UV apparatus (30) will now be detailed which is employed for an excimer UV treatment.

FIG. 4 is a view to explain the principle of excimer UV apparatus (30).

In FIG. 4, (u) is an excimer UV lamp; (q) is quartz glass which covers excimer UV lamp (u); (p) is a purging gas; (d2) is a gap between quartz glass (q) and the surface of metal support (s); and (s) is a metal support on which the film is formed.

In the present embodiment, by employing excimer UV lamp (u) shown in FIG. 4, ultraviolet rays of a primary wavelength of 172 nm are exposed to metal support (s) at a radiation amount of 1-3,000 mJ/cm². Raw material gases such as organic solvent vapor such as methylene chloride or alcohol and monomer gases such as acetylene, which are employed to form a surface treatment film, may be mixed with purging gas (p) and introduced. It is preferable that the feed opening of purging gas (p) is arranged upstream of excimer UV apparatus (30) and on the inlet side where metal support (s) enters below the excimer UV apparatus. When these raw material gases are not mixed with purging gas (p), they are accompanied on the surface of metal support (s) and conveyed below excimer UV apparatus (30), whereby reaction and formation of a surface treatment film may be carried out.

Further, when gap (d2) between quartz glass (q) and metal support (s) is excessively small, direct contact with the surface of metal support (s) may occur resulting in damage, while when the gap is excessively large, high energy of excimer UV is absorbed via oxygen and water in the ambience, effects of the formation of the treatment film on the surface of metal support (s) deteriorate. Consequently, the gap is preferably 0.5-4 mm, but is more preferably 1-3 mm.

When surface treating apparatus (200) such as aforesaid atmospheric pressure plasma apparatus (20) or excimer UV apparatus (30), employed to form a surface treatment film on the surface of metal support (s), is brought in an optical film forming line, actions to maintain clean degree become a problem. Specifically, with regard to the structure, in the atmospheric pressure plasma apparatus, which is structured to discharge generated dust to the interior of the film forming line, actions to maintain the clean degree become critical.

In FIG. 1, metal support (7) which casts dope (1a) is, for example, a stainless steel (SUS 316 or SUS 304) looped belt. In FIG. 2, metal support (6) which casts dope (1a) is, for example, a drum which is prepared by applying hard chromium plating to the surface of a stainless steel drum. In the present embodiment, employed is metal support (6) or (7) which has been subjected to ultra-mirror polishing on its surface, and the following surface treatment film is formed on these surfaces.

NOW During film formation by casting the dope onto metal support (6) or (7) as described above, a treatment to form the surface treatment film is carried out in the zone represented by symbol “A” in FIGS. 1 and 2. Namely, web (1b) is peeled from metal support (6) or (7), and thereafter, during the period while dope (1b) is again cast from casting die (3), a zone is limited where the surface of metal support (6) or (7) is, so-called not-covered.

According to the method of the present embodiment, by minimizing so-called poor peeling region of metal support (6) or (7), conventional limitations for film manufacturing conditions are decreased, and the selection range for film manufacturing conditions is significantly widened. At the same time, mold releasing properties (peeling properties) of film from metal support (6) or (7) are enhanced and highly smooth peeling properties are realized in the entire peeling residual solvent region, whereby variation of the peeling position in the lateral direction is reduced. At the same time, fluctuation of retardation (Re) values is significantly reduced, whereby it is possible to manufacture optical film exhibiting optical characteristics of excellent transparency and flatness and to enable an increase of the manufacturing rate, resulting in enhancement of film productivity. Consequently, it is possible to provide an optical film manufacturing method, an optical film, a polarizing plate, and a display device, which are capable of meeting recent demands for decreasing film thickness and increasing width, and enhancing quality of a polarizing plate protective film.

In the embodiments of the present invention, the dope (1a) for manufacturing an optical film contains a resin such as a cellulose ester resin as a main component and further contains at least one of a plasticizer, a retardation regulator, a UV absorber, minute particles and a low molecular weight material, and a solvent.

Hereafter, these materials will be explained.

In the manufacturing method of the optical film in the embodiments of the present invention, various resins can be used as a film material. Of these, cellulose ester is preferable.

Cellulose ester resins include a cellulose ester in which the hydroxyl group originated from cellulose is replaced with such as an acyl group. Examples include cellulose acylates such as cellulose acetate, cellulose triacetate, cellulose acetate propionate, cellulose acetate butyrate, or cellulose acetate propionate, as well as cellulose acetate having an aliphatic polyester grafted side chain. Of these, preferred are cellulose acetate, cellulose acetate propionate and cellulose acetate having an aliphatic polyester grafted side chain. Other substituents may be present in the range which does not adversely affect the effects of the embodiments of the present invention.

As an example of cellulose triacetate, the degree of substitution by the acetyl group is preferably 2.0 or more but 3.0 or less. By controlling the degree of substitution within the above ranges, it is possible to obtain desired molding properties, and it is also possible to achieve a desired in-plane retardation (Ro), as well as a desired retardation in the thickness direction (Rt). When the degree of substitution of the acetyl group is smaller than the above range, resistance to humidity and heat, specifically dimensional stability under a humid and high temperature atmosphere as a retardation film is occasionally degraded, while when it is larger than the above range, required retardation characteristics are occasionally not obtained.

Raw cellulose materials of cellulose ester resins employed in the present invention are not specifically limited, and listed as such may be cotton linter, wood pulp, and kenaf. Further, it is possible that the cellulose ester resins prepared employing the above materials may be blended at an appropriate ratio.

In the embodiments of the present invention, the number average molecular weight of the cellulose ester is preferably 60,000-300,000, whereby high mechanical strength of the film can be obtained, and the number average molecular weight is more preferably 70,000-200,000.

In the embodiments of the present invention, various additives may be blended with the cellulose ester.

In the method of manufacturing an optical film according to the embodiments of the present invention, it is preferable to use a dope composition in which cellulose ester and an additive which reduces the retardation in the thickness direction of the film (Rt) are blended.

In the embodiments of the present invention, it is important to reduce the retardation in the thickness direction of the cellulose ester film (Rt) in order to enlarge the viewing angle of a liquid crystal display driven by an IPS (In-Plane-Switching; response within a plane) mode. In the embodiments of the present invention, the following additives which reduce the retardation in thickness direction of the film (Rt) may be cited.

Generally, a retardation value of a cellulose ester film is obtained as a sum of a retardation value originated from the cellulose ester film and a retardation value originated from the additive. Therefore, an additive which reduce a retardation value means an additive which disturbs the orientation of cellulose ester while the additive itself has small tendency to be oriented and/or has a small polarizing anisotropy, to effectively reduce the retardation in the thickness direction of the film (Rt). For the additive capable of disordering the orientation of cellulose ester, an aliphatic compound is more preferable than an aromatic compound.

The concrete retardation reducing agent is, for example, polyesters represented by the following Formula (1) or Formula (2).

B1-(G-A-)mG-B1 Formula (1)

B2-(G-A-)nG-B2 Formula (2)

wherein B1 represents a monocarboxylic acid component, B2 represents a monoalcohol component, G represents an dialcohol component, and A represents a dibasic acid component. It is the characteristic feature that none of B1, B2, G and A contains an aromatic ring. Each of m and n represents a repeat number.

As the monocarboxylic acid component represented by B1, a known aliphatic or alicyclic monocarboxylic acid can be used without any limitation.

The following materials can be cited as examples of preferable monocarboxylic acid, however, the present invention is not limited thereto.

As the aliphatic monocarboxylic acid, an aliphatic acid having a straight chain or a branched chain each containing from 1 to 32 carbon atoms is preferably applied. The number of the carbon atoms is preferably from 1 to 20 and more preferably from 1 to 12. The inclusion of acetic acid is preferable because the compatibility with the cellulose ester is increased and mixing of acetic acid and another monocarboxylic acid is also preferable.

Examples of preferable monocarboxylic acid include a saturated aliphatic acid such as formic acid, acetic acid, propionic acid, butyric acid, valeric acid, capronic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachinic acid, behenic acid, lignocelic acid, cerotic acid, heptaconic acid, montanic acid, melicic acid and laccelic acid, and an unsaturated aliphatic acid such as undecylenic acid, oleic acid, sorbic acid, linolic acid, linolenic acid and arachidonic acid.

As the alcohol component represented by B2, a known alcohol can be applied without any limitation. For example, a saturated or unsaturated aliphatic alcohol having a straight or branched chain containing from 1 to 32 carbon atoms can be applied. The number of the carbon atoms is preferably from 1 to 20 and more preferably from 1 to 12.

As a dialcohol component represented by G, the following materials can be cited but the present invention is not limited to them. Examples of a dialcohol include ethylene glycol, diethylene glycol, 1,2-propylene glycol, 1,3-propylene glycol, 1,2-butylene glycol, 1,3-butylene glycol, 1,4-butylene glycol, 1,5-pentanediol, 1,6 hexanediol, 1,5-pentylene glycol, triethylene glycol and tetraethylene glycol. Among them, ethylene glycol, 1,2-propylene glycol, 1,3-propylene glycol, 1,2-butylene glycol, 1,3-butylene glycol, 1,4-butylene glycol, 1,4-hexandiol, diethylene glycol and triethylene glycol are preferable, and 3-propylene glycol, 1,4-butylene glycol, 1,6-hexanediol and diethylene glycol are further preferably applied.

As the dibasic acid (dicarboxylic acid) represented by A, aliphatic and alicyclic dibasic acids are preferable, of which examples include malonic acid, succinic acid, glutaric acid, adipic acid, pimelic acid, suberic acid, azelaic acid, sebacic acid, undecanedicarboxylic acid and dodecanedicarboxylic acid. Specifically, at least one selected from ones having from 4 to 12 carbon atoms is used. Two or more kinds of the dicarboxylic acid may be used in combination.

In above Formulas (1) and (2), the repeat numbers m and n each are preferably from 1 to 170.

The weight average molecular weight of the polyester is preferably not more than 20,000 and more preferably not more than 10,000. The polyester having a weight average molecular weight of from 500 to 10,000 shows good compatibility with the cellulose ester and causes limited evaporation and volatilization in the film forming process.

The condensation polymerization of the polyester is carried out by an ordinary method. For example, the polyester can be easily synthesized by a direct reaction of the above dibasic acid with the glycol, a thermally melting condensation method by polyesterization reaction or ester-exchanging reaction of the dibasic acid or its alkyl ester such as methyl ester of the dibasic acid with the glycol, or a method by dehydrohalogenation reaction of a acid chloride of such the acid with the glycol. The polyester having a weight average molecular weight not so large is preferably synthesized by the direct reaction method. The polyester having a molecular weight distribution rising in the low molecular weight side shows very high compatibility with the cellulose ester so that the cellulose ester film having low moisture permeability and high transparency can be obtained.

A known method can be applied without any limitation for controlling the molecular weight. For example, the molecular weight can be controlled under a suitable reacting condition by controlling the adding amount of a mono-valent acid or alcohol in a method for blocking the terminal of the molecular by the mono-valent acid or the mono-valent alcohol. In such the case, the use of the mono-valent acid is preferable from the viewpoint of the stability of the polymer. For the acid, ones which are difficultly distillated out from the system during the polymerization-condensation reaction and easily distillated out after the reaction such as acetic acid, propionic acid and butyric acid are selected. These acids may be used in a mixed state. In the case of the direct reaction, the molecular weight can be controlled by stopping the reaction suitable timing according to the amount of water distillated out from the system during the reaction. Moreover, the control can be carried out by biasing the charging mole number of the glycol or the dibasic acid or by controlling the reaction temperature.

The content of the polyester represented by the above Formula (1) or (2) is preferably 1-40% by mass and specifically preferably 5-15 by mass, based on the mass of cellulose ester.

In the present embodiment, the following materials can be further cited as an additive to lower the retardation value in the thickness direction of the film (Rt).

The dope used for the production of the optical film in the present embodiment mainly contains cellulose ester, a polymer (a polymer obtained by polymerizing an ethylenically unsaturated monomer, such as an acryl polymer) as an additive which reduces the retardation value (Rt), and an organic solvent.

In the present embodiment, when the polymer as an additive which reduces the retardation value in the thickness direction (Rt) is synthesized, molecular weight control is difficult in common polymerization. Therefore, it is preferable to employ a method which enables molecular weights to be as uniform as possible in such a manner that the molecular weights do not become excessively large. Such a method includes a method of using a peroxide polymerization initiator such as cumene peroxide or t-butyl hydroperoxide, a method of using a larger amount of a polymerization initiator compared to common polymerization, a method of using a chain transfer agent such as a mercapto compound or a carbon tetrachloride in addition to a polymerization initiator, a method of using a polymerization terminating agent such as benzoquinone or dinitrobenzene in addition to a polymerization initiator, and further a method of carrying out bulk polymerization by use of a compound having one thiol group and secondary hydroxyl group, or by use of a polymerization catalyst prepared in combination of the compound with an organic metal compound, as disclosed in Unexamined Japanese Patent Application Publication (hereinafter referred to as JP-A) Nos. 2000-128911 and 2000-344823. In the present embodiment, any of these is preferably used, and specifically any of the methods described in the above patent publications is preferable.

In the present embodiment, examples of a monomer as a monomer unit which constitutes the polymer as an effective additive which reduces the retardation value (Rt) will be listed below, however, the present invention is not limited thereto.

Examples of an ethylenically unsaturated monomer constituting the polymer obtained by polymerizing an ethylenically unsaturated monomer as an additive which reduces the retardation value in the thickness direction of the film (Rt) will be described below. Examples of vinyl ester include vinyl acetate, vinyl propionate, vinyl butyrate, vinyl valerate, vinyl pivalate, vinyl capronate, vinyl caprate, vinyl laurate, vinyl myristate, vinyl Palmitate, vinyl stearate, vinyl cyclohexane carboxylate, vinyl octylate, vinyl methacrylate, vinyl crotonate, vinyl sorbate, vinyl benzoate and vinyl cinnamate.

Examples of acrylic acid ester include acrylic acid methyl, acrylic acid ethyl, acrylic acid propyl (i-, n-), acrylic acid butyl (n-, s-, t-), acrylic acid pentyl (n-, s-), acrylic acid hexyl (n-, i-), acrylic acid heptyl (n-, i-), acrylic acid octyl (n-, i-), acrylic acid nonyl (n-, i-), acrylic acid myristyl (n-, i-), acrylic acid cyclohexyl, acrylic acid (2-ethylhexyl), acrylic acid benzyl, acrylic acid phenethyl, acrylic acid (∈-caprolactone), acrylic acid (2-hydroxyethyl), acrylic acid (2-hydroxypropyl), acrylic acid (3-hydroxypropyl), Acrylic acid (4-hydroxy butyl), acrylic acid (2-hydroxy butyl), acrylic acid-p-hydroxy methylphenyl, acrylic acid-p-(2-hydroxyethyl)phenyl, and the like. Examples of methacrylic acid ester include compounds in which the above acrylic acid ester is replaced to methacrylic acid ester.

Examples of unsaturation acids include acrylic acid, methacrylic acid, maleic anhydride, crotonic acid and itaconic acid.

A polymer constituting the above monomer may be a copolymer or a homopolymer, and a homopolymer of vinyl ester, a copolymer of vinyl ester, or a copolymer of vinyl ester with acrylic acid or methacrylic acid ester is preferable.

In the present embodiment, an acrylic polymer designates a homopolymer or a copolymer of acrylic acid, or methacrylic acid alkyl ester, which does not possess a monomer unit having an aromatic ring or a cyclohexyl group.

Examples of the acrylic acid ester monomer which does not possess an aromatic ring or a cyclohexyl group include acrylic acid methyl, acrylic acid ethyl, acrylic acid propyl (i-, n-), acrylic acid butyl (n-, s-, t-), acrylic acid pentyl (n-, s-), acrylic acid hexyl (n-, i-), acrylic acid heptyl (n-, i-), acrylic acid octyl (n-, i-), acrylic acid nonyl (n-, i-), acrylic acid myristyl (n-, i-), acrylic acid (2-ethylhexyl), acrylic acid (∈-caprolactone), acrylic acid (2-hydroxyethyl), acrylic acid (2-hydroxypropyl), acrylic acid (3-hydroxypropyl), acrylic acid (4-hydroxybutyl), acrylic acid (2-hydroxybutyl), acrylic acid (2-methoxyethyl), acrylic acid (2-ethoxyethyl), and the like, or compounds in which the above acrylic acid ester is replaced to methacrylic acid ester.

The acrylic monomer is a homopolymer or a copolymer of the above polymer, but the acrylic monomer has preferably an acrylic acid methylester monomer unit of not less than 30% by mass, preferably a methacrylic acid methylester monomer unit of not less than 40% by mass, and a homopolymer of acrylic acid methyl or of methacrylic acid methyl is particularly preferable.

Each of the polymer obtained by polymerizing an abovementioned ethylenically unsaturated monomer, and the acrylic polymer exhibits excellent compatibility with cellulose ester, excellent productivity of the optical film without evaporation and volatilization of the polymer in the film forming process, excellent retention of the polymer when used as a polarizing plate protective film, small moisture permeability and excellent dimensional stability.

In the case of a hydroxyl group-containing acrylic acid or methacrylic acid ester monomer, the unit is not a constituting unit of homopolymer, but that of copolymer. In this case, it is preferred that a hydroxyl group-containing acrylic acid or methacrylic acid ester monomer unit of 2-20% by mass is contained in an acrylic polymer.

In the present embodiment, the dope composition preferably contains cellulose ester and an acrylic polymer having a weight average molecular weight of 5,000 or more but 30,000 or less as an additive which reduces the retardation in the thickness direction of the film (Rt).

In the method of manufacturing an optical film according to the present embodiment, the dope composition preferably contains cellulose ester and an acrylic polymer having a weight average molecular weight of 5,000 or more but 30,000 or less as an additive which reduces the retardation in the thickness direction of the film (Rt).

In the present embodiment, when the weight average molecular weight of the polymer as an additive which reduces the retardation in the thickness direction of the film (Rt) is 500 or more but 3,000 or less, or the weight average molecular weight of the polymer is 5,000 or more but 30,000 or less, the polymer exhibits excellent compatibility with cellulose ester and causes limited evaporation and volatilization of the polymer in the film forming process. Further, the cellulose ester film, after film formation, exhibits excellent transparency, extremely small moisture permeability and excellent dimensional stability, whereby exhibiting an excellent property as a polarizing plate protective film.

In the present embodiment, as an additive which reduces the retardation in the thickness direction of the film (Rt), a polymer having a hydroxyl group as a side chain may also be preferably used. Similarly to the foregoing monomer, acrylic acid or methacrylic acid ester is preferable as a monomer unit having a hydroxyl group, and examples include acrylic acid (2-hydroxyethyl), acrylic acid (2-hydroxypropyl), acrylic acid (3-hydroxypropyl), acrylic acid (4-hydroxy butyl), acrylic acid (2-hydroxy butyl), acrylic acid-p-hydroxy methylphenyl, acrylic acid-p (2-hydroxyethyl)phenyl, or compounds in which this acrylic acid is replaced to a methacrylic acid. Of these, acrylic acid-2-hydroxyethyl or methacrylic acid-2-hydroxyethyl is preferable. A hydroxyl group-containing acrylic acid ester or methacrylic acid ester monomer unit of 2-20% by mass is preferably contained in the polymer, and that of 2-10% by mass is more preferably contained.

When the foregoing polymer contains the above hydroxyl group-containing monomer unit of 2-20% by mass, exhibited are not only excellent compatibility with a cellulose ester, excellent retension of the polymer, excellent dimensional stability and low moisture permeability, but also excellent adhesiveness to a polarizer as a polarizing plate protective film and improved polarizing plate durability.

In the present embodiment, the polymer has preferably a hydroxyl group at least one of the polymer ends of the main chain. The methods of incorporating a hydroxyl group into the polymer ends are not specifically limited, but include a method of employing a radical polymerization initiator having a hydroxyl group such as azobis(2-hydroxyethylbutyrate) and the like; a method of employing a chain transfer agent having a hydroxyl group such as 2-mercaptoethanol and the like; a method of employing a polymerization terminator having a hydroxyl group; a method of incorporating a hydroxyl at the ends via ionic polymerization; and a method of mass-polymerization employing a catalyst as a compound having a thiol group and a secondary hydroxyl group, or employing a catalyst used in combination with the aforementioned compound and an organometallic compound, disclosed in Japanese Patent O.P.I. Publication Nos. 2000-128911 and 2000-344823. Of these, the method disclosed in these patent publication Nos. are particularly preferable. Such a polymer described in these patent publication Nos. is commercially available on the market, and examples thereof include Actflow produced by Soken Kagaku Co., Ltd., which is preferably used in the invention.

It is to be understood in the present invention that the above polymer having a hydroxyl group at the ends and/or a polymer having a hydroxyl group as a side chain have/has improved such the properties of compatibility of polymer and transparency.

In the present embodiment, as an additive which reduces the retardation in the thickness direction of the film (Rt), in addition to the above materials, the following compounds may be cited, for example, the ester compound of a diglycerin type polyvalent alcohol and the fatty acids described in JP-A No. 2000-63560, the esters or ethers of sugar alcohol of hexose described in JP-A No. 2001-247717, the tri-phosphate of a fatty acid alcohol described in JP-A No. 2004-315613, the compounds described in Formula (1) of JP-A No. 2005-41911, the phosphate compounds described in JP-A No. 2004-315605, the phosphate compounds described in JP-A No. 2004-315605, the styrene oligomers described in JP-A No. 2005-105139, and the polymers of polymerized styrene type monomer described in JP-A No. 2005-105140.

In the present embodiment, the additive which reduces the retardation in the thickness direction of the film (Rt) can also be obtained by the following method.

A cellulose ester film having a thickness of 80 μm was formed by applying a dope prepared by dissolving cellulose ester in a mixed organic solvent containing methyl acetated and acetone on a glass plate, followed by drying at 120° C./15 min. The retardation value in the thickness direction of the cellulose ester film was measured, which was then designated as Rt1.

Next, a dope was prepared by dissolving cellulose ester added with 10% by mass of the abovementioned additive polymer in a mixed organic solvent containing methyl acetated and acetone. A cellulose ester film having a thickness of 80 μm was formed in the same manner as above using this dope. The retardation value in the thickness direction of the cellulose ester film was measured, which was then designated as Rt2.

When the above two retardation values in the thickness direction of the film meet the following relationship, the additive polymer which was added in the cellulose ester can be states as an additive which reduces the retardation in the thickness direction of the film (Rt):

Rt2<Rt1

In the present embodiment, the retardation value in the thickness direction of the film (Rt) is −10 nm to +10 nm, and preferably −5 nm to +5 nm. In both cases, when the retardation value in the thickness direction of a cellulose ester film (Rt) is less than −10 nm and when it is larger than +10 nm, the viewing angle of the liquid crystal display becomes narrower, whereby the effect of the present invention cannot be obtained.

In the present embodiment, the in-plane retardation (Ro) of the cellulose ester film is 0 nm to +5 nm, preferably 0 nm to +2 nm, further preferably 0 nm to +1 nm, and specifically preferably about 0 nm. In both cases, when the in-plane (Ro) retardation value of a cellulose ester film is less than 0 nm and when it is larger than +5 nm, the viewing angle of the liquid crystal display becomes narrower, whereby the effect of the present invention cannot be obtained. The optical film according to the present embodiment preferably has an in-plane retardation value (Ro) of 30-300 nm and a retardation value in the thickness direction of the film (Rt) of 70-400 nm, Ro and Rt being defined by the following equations and measured under the condition of 23° C. and 55% RH.

The content of the additive which reduces the retardation value in the thickness direction of the film (Rt) is preferably 5-25%, by mass based on the mass of cellulose ester. When the content of the additive which reduces the retardation value in the thickness direction of the film (Rt) is less than 5% by mass, it is unfavorable because the effect to reduce the retardation value in the thickness direction of the film (Rt) is not enough, and when the content of the additive which reduces the retardation value in the thickness direction of the film (Rt) is larger than 25% by mass, it is also unfavorable because the stability of the additive in the film is lowered to cause, for example, so-called bleed-out.

In the present embodiment, it is possible to obtain the retardation values of the film as follows. By employing an automatic birefringence meter, KOBRA-21ADH (produced by Oji Scientific Instruments) three-dimensional refractive indexes are determined at a wavelength of 590 nm under the condition of 23° C. and 55% RH, and the retardation values of the film are calculated using the obtained refractive indexes Nx, Ny, and Nz.

Ro=(Nx−Ny)×d

Rt={(Nx+Ny)/2−Nz}×d

wherein Nx, Ny, and Nz each represent a refractive index in principal axis x, y, and z directions of a refractive index ellipsoid, while Nx and Ny each represent a refractive index in the in-plane direction of a film, and Nz represents the refractive index in the thickness direction of a film, in which Nx Ny, and d represents the thickness (in nm) of a film.

In the present embodiment, the cellulose ester film has the following relationship between angle θ (in radian) which is the angle of the slow axis direction against the film forming direction and retardation value Ro in the in-plane direction, whereby the cellulose ester film can be specifically preferably used as a cellulose ester film for a polarizing plate protective film.

P≦1−sin²(2θ)sin²(πRo/λ)

wherein P is 0.9999 or less. θ represents the angle (in radian) of the in-plane slow axis direction of the film against the film forming direction (the longitudinal direction of the film), λ represents 590 nm which is the wavelength of the light employed during determination of three-dimensional refractive indexes to determine above Ny, Nz and θ, and π represents number π.

In the method of manufacturing an optical film according to the present embodiment, an organic solvent which has a good solubility of the above cellulose derivatives is called a good solvent and its main effect is to solve the cellulose derivatives. Among the good solvents, organic solvents that are used in large quantity is called a main or primary (organic) solvent.

Typical good solvents are, for example,

ketones such as acetone, methyl ethyl ketone, cyclopentanone, and cyclohexanone,

ethers such as tetrahydrofuran (THF), 1,4-dioxane, 1,3-dioxorane, and 1,2-dimethoxyethane,

esters such as methyl formate, ethyl formate, methyl acetate, ethyl acetate, amyl acetate, and γ-butyrolactone,

methyl cellosolve, dimethyl imidazolynone, dimethyl formamide, dimethyl acetoamide, acetonitrile, dimethyl sulfoxide, sulfolane, nitro ethane, methylene chloride, and acetomethyl acetate.

Among the above solvents, preferable are 1,3-dioxorane, THF, methyl ethyl ketone, acetone, methyl acetate and methylene chloride.

In addition to the above organic solvent, the dope should preferably contain 1 to 40 mass % of alcohol of 1 to 4 carbon atoms (per molecule). Alcohols work as a gelation solvent which gelates a web when the ratio of alcohol in the solvent becomes greater during evaporation of the solvent from the dope flown over a metal support, strengthen the web, and facilitates separation of the web from the support. Alcohols also work to accelerate dissolution of the cellulose derivative into non-chlorine organic solvent when the ratio of alcohols is less.

Examples of an alcohol having 1 to 4 carbon atoms include methanol, ethanol, n-propanol, iso-propanol, n-buthanol, sec-buthanol, tert-buthanol, and propylene glycol monomethyl ether. Among these, ethanol is preferable because it excels at stability of dope and has a comparatively-low boiling point, good drying property, and little toxicity. These organic solvents are called poor solvents because they have no ability to dissolve cellulose derivatives.

The most preferable solvent which can satisfy the above conditions and dissolve cellulose derivatives at high concentration is a mixture of methylene chloride and ethyl alcohol whose ratio is in the range of 95:5 to 80:20 or a mixture of methyl acetate and ethyl alcohol whose ratio is in the range of 60:40 to 95:5.

The optical film according to the present embodiment may contain, for example, a plasticizer which provides workability, flexibility, and dampproofing to the film; particles (matting agent) which provides sliding property to the film; a UV absorber which provides a UV absorbing function to the film; or an antioxidant which prevents deterioration of the film.

In the present embodiment, although the plasticizer is not specifically limited, the plasticizer preferably has a functional group capable of interacting via a hydrogen bond with the cellulose derivative or a polycondensation product of a reactive metal compound capable of hydrolysis polycondensation so that haze, bleeding out or evaporation of the plasticizer from the film does not occur.

Examples of such a functional group include a hydroxyl group, an ether group, a carbonyl group, an ester group, a residue of carboxylic acid, an amino group, an imino group, an amido group, a cyano group, a nitro group, a sulfonyl group, a residue of sulfonic acid, a phosphonyl group and a residue of phosphonic acid. Of these, a carbonyl group, an ester group and phosphonyl a group are preferable.

Examples of a preferably usable plasticizer include a phosphate type plasticizer, a phthalate type plasticizer, a trimelitate type plasticizer, a pyromelitate type plasticizer, a polyvalent alcohol ester type plasticizer, a glycolate type plasticizer, a citrate type plasticizer, an aliphatic acid ester type plasticizer, a calboxylate type plasticizer and a polyester type plasticizer. Of these, non-phospahte type plasticizers, for example, a polyvalent alcohol ester type plasticizer, a glycolate type plasticizer, and a polyvalent carboxylic acid ester type plasticizer are specifically preferable.

The polyvalent alcohol ester is the ester of a di- or more-valent alcohol and a mono-carboxylic acid and preferably has an aromatic ring or a cycloalkyl ring in the molecule thereof.

The poly-valent alcohol is represented by the following Formula (3).

R1-(OH)n Formula (3)

(In the above, R1 is an n-valent organic group, and n is an integer of 2 or more.)

As examples of a polyvalent alcohol, the following materials may be citd, however, the present invention is not limited thereto.

Examples of a preferable polyvalent alcohol include adonitol, arabitol, ethylene glycol, diethylene glycol, triethylene glycol, tetraethylene glycol, 1,2-propanediol, 1,3-propanediol, dipeopylene glycol, tripropylene glycol, 1,2-butnaediol, 1,3-butanediol, 1,4-butanediol, dibutylene glycol, 1,2,4-bunanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol. Specifically, triethylene glycol, tetraethylene glycol, dipeopylene glycol, tripropylene glycol, sorbitol, triethylol propane and xylitol are preferred.

The monocarboxylic acid used in the polyvalent alcohol ester according to the present embodiment is not specifically limited, and any known aliphatic monocarboxylic acid, alicyclic monocarboxylic acid and aromatic monocarboxylic acid may be employed. The alicyclic monocarboxylic acid and aromatic monocarboxylic acid are preferable in view of the moisture permeability and the retention of the plasticizer.

Examples of a preferable monocarboxylic acid are listed below but the present invention is not limited to them.

A straight or side chain fatty monocarboxylic acid having 1-32 carbon atoms is preferably employed. The number of carbon atoms is more preferably 1-20, and particularly preferably 1-10. The incorporation of acetic acid is preferable for raising the compatibility with the cellulose derivative, and the mixing of acetic acid with another carboxylic acid is also preferable.

As the preferable aliphatic monocarboxylic acid, a saturated fatty acid such as acetic acid, propionic acid, butylic acid, valeric acid, caproic acid, enantic acid, caprylic acid, pelargonic acid, capric acid, 2-ethyl-hexane carboxylic acid, undecylic acid, lauric acid, dodecylic acid, myristic acid, pentadecylic acid, palmitic acid, heptadecylic acid, stearic acid, nonadecanic acid, arachic acid, behenic acid, lignocelic acid, serotic acid, heptacosanic acid, montanic acid, melisic acid and lacceric acid, and an unsaturated fatty acid such as undecylenic acid, oleic acid, sorbic acid, linolic acid, linolenic acid and arachidonic acid can be exemplified.

Examples of preferable alicyclic carboxylic acid include cyclopentene carboxylic acid, cyclohexane carboxylic acid, cyclooctane carboxylic acid and derivatives thereof.

Examples of preferable aromatic carboxylic acid include ones formed by introducing an alkyl group onto the benzene ring of benzoic acid such as benzoic acid and toluic acid, an aromatic monocarboxylic acid having two or more benzene rings such as biphenylcarboxylic acid, naphthalene carboxylic acid and tetralin carboxylic acid and derivatives thereof, and benzoic acid is specifically preferable.

The molecular weight of the polyvalent alcohol is preferably 300-1,500, and more preferably 350-750 though the molecular weight is not specifically limited. Larger molecular weight is preferable for low volatility and smaller molecular weight is preferable in view of the moisture permeability and the compatibility with the cellulose derivative.

The carboxylic acid employed in the polyvalent alcohol ester may be one kind or a mixture of two or more kinds of them. The hydroxyl group in the polyvalent alcohol may be entirely esterified or partially left.

The glycolate type plasticizer is not specifically limited, however, preferably used are those having an aromatic ring or a cycloalkyl ring in the molecule. Examples of a preferable glycolate type plasticizers include butylphthalylbutyl glycolate, ethylphthalylethyl glycolate, and methylphthalylethyl glycolate.

Examples of a phosphate type plasticizer include triphenyl phosphate, tricresyl phosphate, cresyl diphenyl phosphate, octyl diphenyl phosphate, diphenyl biphenyl phosphate, trioctyl phosphate and tributyl phosphate. Examples of a phthalate type plasticizer include diethyl phthalate, dimethoxethyl phthalate, dimethyl phthalate, dioctyl phthalate, dibutyl phthalate, di-2-ethylhexyl phthalate and dicyclohexyl terephthalate. In the present embodiment, it is preferable that the phosphate type plasticizer is not substantially contained.

The expression “not substantially contained” means that the content of the phosphate type plasticizer is less than 1% by mass, preferably 0.1% by mass, more preferably 0% by mass. These plasticizers may be used alone or in combination of two or more kinds thereof.

The content of the plasticizer is preferably 1-20% by mass, more preferably 6-16% by mass, and specifically preferably 8-13% by mass. The content of the plasticizer of less than 1% by mass based on the mass of the cellulose derivative is not preferable because the effect to lower the moisture permeability is small, and the content of the plasticizer of more than 20% by mass is not preferable because the plasticizer may bleed out of the film, whereby the property of the film may be deteriorated.

In order to provide lubricating properties, it is preferable that minute particles such as matting agents are incorporated in the cellulose derivative of the present embodiment. Listed as such minute particles are those composed of inorganic or organic compounds.

Examples of minute particles composed of inorganic compounds include those composed of silicon dioxide, titanium dioxide, aluminum oxide, zirconium oxide, and tin oxide. Of these, preferred are minute particles composed of compounds incorporating silicon atoms, and minute silicon dioxide particles are particularly preferred. Listed as minute silicon dioxide particles are AEROSIL 200, 200V, 300, R972, R972V, R974, R202, R812, R805, OX50, and TT600, all produced by Aerosil Co.

Examples of minute particles composed of organic compounds include those composed of acrylic resins, silicone resins, fluororesins, and urethane resins.

The primary particle diameter of the minute particles is not particularly limited. The final average particle diameter in the film is preferably about 0.05-about 5.0 μm, but is more preferably 0.1-1.0 μm.

The average diameter of minute particles refers to the average value of the particle length in the major axis direction of the film viewed when the cellulose ester film is observed employing an electron microscope or an optical microscope. The observed particles in the film may be either primary particles, or secondary particles which are formed by coagulation of primary particles, but most of the particles usually observed are secondary particles.

One example of a measurement method follows. Vertical cross section at 10 randomly selected sites per film is photographed, and the number of particles at a major axis length of 0.05-5 μm in an area of 100 μm² is recorded. Subsequently, the average value of the measured length in the major axis direction is obtained, and the average value of 10-position measurements is designated as the average particle diameter.

In the case of minute particles, the primary particle diameter, the particle diameter after dispersion in solvents, and the particle diameter after the addition to the film tend to vary. Further, particles in the film are combined with cellulose ester to form coagulated particles. Thereby, it is critical to control the particle diameter of the finally formed particles in the film.

When the above average diameter of minute particles exceeds 5 μm, haze may increase and the minute particles may function as foreign matter in a wound film to result in problems. On the other hand, when it is less than 0.05 μm, it becomes difficult to provide lubrication to the film.

The used amount of the above minute particles in cellulose ester is commonly 0.04-0.5 percent by mass with respect of the cellulose ester, is preferably 0.05-0.3 percent by mass percent, but is more preferably 0.05-0.25 percent by mass. When the added amount of the minute particles is at most 0.04 percent by mass, the surface is excessively smooth, blocking results due to an increase in friction coefficient, while when it exceeds 0.5 percent by mass, the friction coefficient of the film surface is excessively lowered, resulting in non-uniform winding during winding, a decrease in transparency and an increase in haze, whereby the resulting film offers no value as a film for liquid crystal displays. Consequently, it is essential to control the addition amount within the above range.

It is preferable that dispersing minute particles is processed in such a manner that a composition prepared by mixing minute particles with solvents, employing a high pressure homogenizer, is processed employing a high pressure homogenizer. The high pressure homogenizer, employed in the present invention, is an apparatus which creates specific conditions such as high shearing and high pressure by allowing a composition prepared by mixing minute particles with solvents to pass through a narrow pipe at a high flow rate.

When processed in such a high pressure homogenizer the maximum pressure condition in the homogenizer, for example, is preferably at least 980 N/cm² in the narrow pipe at a diameter of 1-2,000 μm, but more preferably 1,960 N/cm². During operation, even though the maximum rate reaches 100 m/second, a homogenizer is preferred in which the heat transfer rate reaches 1850×105 J/hr.

Listed as a high pressure homogenizer, described as above, are, for example, an ultra-high pressure homogenizer (trade name MICROFLUIDIZER), produced by Microfluidics Corporation, or NANOMIZER, produced by Nanomizer Co. In addition, listed are MANTON GAULIN type high pressure homogenizers such as HOMOGENIZER, produced by Izumi Food Machinery Co.

In the present embodiment, after dispersing the particles in a solvent containing 25-100% by mass of lower alcohol, the dispersion is mixed with a dope in which cellulose ester (cellulose derivative) is dissolved in a solvent, the mixed liquid is cast on a metal support, and then the cast film is dried to form a cellulose ester film.

The content of the lower alcohol is preferably 50-100% by mass and more preferably 75-100% by mass.

Examples of a preferable lower alcohol include methyl alcohol, ethyl alcohol, propyl alcohol, isopropyl alcohol and butyl alcohol.

A solvent other than the lower alcohol is not specifically limited, however, it is preferable that a solvent used in the film forming process is used.

The particles are dispersed in a solvent at a content of 1-30% by mass. The content of the particles higher than the above in the dispersion is not preferred, because the viscosity of the dope quickly increases. The content of the particles is preferably 5-25% by mass, and more preferably 10-20% by mass.

A UV absorption function of a film is preferably provided to various optical films, for example, a polarizing plate protective film, a retardation film and an optical compensation film, from the viewpoint of preventing the deterioration of the liquid crystal. Such a UV absorption function may be provided by incorporating a material which absorbs UV light into the cellulose derivative, or by forming a layer having a UV absorption function on the film constituted from a cellulose derivative.

In the present embodiment, examples of a usable UV absorber include an oxybenzophenone compound, a benzotriazole compound, a salicylic acid ester compound, a benzophenone compound, a cyanoacrylate compound, and a nickel complex, of these, a benzotriazole compound exhibiting limited coloration is preferred. Also preferably employed are UV absorbers disclosed in JP-A Nos. 10-182621 and 8-337574, as well as polymer UV absorbers disclosed in JP-A No. 6-148430.

In view of preventing degradation of a polarizer and liquid crystals, preferred as a UV absorber, are those which efficiently absorb ultraviolet light at a wavelength of 370 nm or less, while in view of liquid crystal display properties, preferred are those which exhibit minimal absorption of visible light at a wavelength of 400 nm or more.

Specific examples of a UV absorber usable in the present embodiment include 2-(2′-hydroxy-5′-methylphenyl)benzotriazole, 2-(2′-hydroxy-3′,5′-di-tert-butylphenyl)benzotriazole, 2-(27-hydroxy-3′-tert-butyl-5′-methylphenyl)benzotriazole, 2-(2′-hydroxy-3′,5′-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl-6-(2H-benzotriazole-2-yl), 2-(2′-hydroxy-3′-tert-butyl-5′-methylphenyl)-5-chlorobenzotriazole, and 2-(2H-benzotriazole-2-yl-6-(straight and branched chain dodecyl)-4-methylphenol, as well as a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-nenzotriazole-2-yl)phenyl]propionate, however, the examples are not limited thereto.

Also preferably employed are commercially available products such as TINUVIN 109, TINUVIN 171 and TINUVIN 326, all produced by Ciba Specialty Chemicals Co.

Listed as specific examples of benzophenone compounds may be 2,4-dihydroxybenzophenone, 2,2′-dihydroxy-4-methoxybenzophenone, 2-hydroxy-4-methoxy-5-sulfobenzophenone, and bis(2-methoxy-4-hydroxy-5-benzoylphenylmethane, however the present invention is not limited thereto.

In the present embodiment, the addition amount of these UV absorbers is preferably 0.01-10% by mass based on the mass of the cellulose ester resin, but is more preferably 0.1-5% by mass. When the used amount is excessively small, the UV absorbing effects may be insufficient, while when it is excessively large, transparency of the film may be lost. The UV absorbers are preferably stable against heat.

Polymer UV absorbers (UV absorbing polymers) disclosed in JP-A Nos. 6-148430 and 2002-47357 are also preferably used in the optical film of the present embodiment. Specifically, the polymer UV absorbers represented by Formula (1) or (2) of JP-A No. 6-148430, or by Formula (3), (6) or (7) of JP-A No. 2002-47357 are preferably used.

An antioxidant is also called a deterioration-preventing agent. An antioxidant is preferably incorporated in a cellulose ester film as an optical film. When a liquid crystal display is stored at an high-temperature and high-humidity condition, the cellulose ester film may deteriorate. An antioxidant is preferably contained in a cellulose ester film in order to prevent or retard the decomposition of the film due to the halogen contained in the residual solvent in the film or the phosphoric acid in a phosphoric acid based plasticizer.

As such an antioxidant, hindered phenol compounds are also preferably employed. Examples of the compounds include 2,6-di-t-butyl-p-cresol, pentaerythityl-tetrakis[3-(3,5-di-t-butyl-4-hydroxyphenyl)propionate], triethylene glycol-bis[3-(3-t-butyl-5-methyl-4-hydroxyphenyl)propionate], 1,6-hexanediol-bis[3-(3,5-di-t-butyl-4-hydroxyphenyl)-propionate, 2,4-bis(n-octyl)-6-(4-hydroxy-3,5-di-t-butylanilino)-1,3,5-triazine, 2,2-thio-diethylene-bis[3-(3,5-t-butyl-4-hydroxyphenyl)propionate, octadecyl-3-(3,5-di-t-butyl-4-hydroxyphenyl)propionate, N,N′-hexamethylene-bis(3,5-di-t-butyl-4-hydroxy-4-hydroxy-hydrocinnamide), 1,3,5-trimethyl-2,4,6-tris(3,5-di-t-butyl-4-hydroxybenzyl)benzene and tris(3,5-di-t-butyl-4-hydroxybenzyl)-isocyanurate. Specifically, 2,6-di-t-butyl-p-cresol, pentaerythityl-tetrakis[3-(3,5-di-t-butyl-4-hydroxyphenyl)propionate] and triethylene glycol-bis[3-(3-t-butyl-5-methyl-4-hydroxyphenyl)-propionate] are preferred. A hydrazine metal inactivation agent such as N,N′-bis[3-(3,5-di-t-butyl-4-hydroxyphenyl)propionyl]hydrazine and a phosphor processing stabilizing agent such as tris(2,4-di-t-butylphenyl)phosphite may be used in combination.

The adding amount of these compounds is preferably 1 ppm to 1.0%, and more preferably from 10 ppm to 1,000 ppm, by mass based on the mass of the cellulose ester.

In the apparatus shown in FIGS. 1 and 2, in which production of the optical film is carried out, it is preferable as a stretching process for the production of optical films used for liquid crystal displays that the web (1b) is dried in a tenter system in which the web is stretched while holding the both edges by, for example, clips, in order to improve the flatness and dimensional stability of the film.

The amount of residual solvent of the web (1b) just before entering the tenter (12) in the stretching process is preferably 10-35% by mass.

In the present embodiment, the stretching ratio of web (1b) in tenter (12) of the stretching process is 1.03-2 times, preferably 1.05-1.8 times, and further preferably 1.05 to 1.6 times. The temperature of the hot air which is blown out from the opening of the hot air blow out slit in tenter (12) is 100-200° C., preferably 110-190°, and further preferably 115-185° C. Hereafter, the web (1b) after stretched by tenter (12) is called as film (9).

It is preferable that drying equipment (10) is provided before and after tenter (12) or only before or after tenter (12) in the stretching process. In drying equipment (10), by passing through a plurality of conveying rollers placed in a staggered manner when viewed from the side, the web is made to meander, whereby the film (9) is dried. The film conveying tension in drying equipment (10) varies depending on the amount of residual solvent in the film conveying process and the drying temperature, but is 0.3-3 N/10 mm, and is more preferably 0.4-2.7 N/mm.

Means for drying film (9) is not specifically limited and usually hot wind, infrared rays, a heating roller and microwave are applied. The hot wind is preferred from the viewpoint of simplicity, for example, film (9) is dried by the drying wind (11a) blown from the hot wind inlet at the rear portion on the ceiling of drying equipment (10) and discharged as exhaust wind (lib) from the outlet at the front portion on the floor of drying equipment (10). The temperature of drying wind (11a) is preferably 40-160° C., and is more preferably 50-160° C. to improve the flatness and dimensional stability of the film.

The above processes from casting to post-drying may be performed in an ambience of air or an inert gas such as nitrogen. In this case, the drying atmosphere is naturally constituted taking into consideration of the explosion limit concentration of solvents.

It is preferable that during the pre-step of introducing the winding process, for example, the cellulose ester film, having completed the conveying drying process, are subjected to an embossing treatment employing an embossing device which is not illustrated.

The height h of embossing (μm) is set to 0.05 to 0.3 time of the film thickness T, and width of embossing W is set to 0.005 to 0.02 time of the film width L. Embossing may be carried out on both surfaces of the film. In this case, height of embossing h1+h2 (μm) is set to 0.05 to 0.3 time of the film thickness T, and width of embossing W is set to 0.005 to 0.02 time of the film width L. For example, when the film thickness is 40 μm, the height of embossing h1+h2 (μm) is set to 2-12 μm. The width of embossing is set to 5-30 mm.

Film (9) after died is wound in a roll using winder (13) to obtain an original roll of the optical film. The residual solvent amount of film (9) after the drying is finished is 0.5% by mass or less, preferably 0.1% by mass or less, whereby film (9) having an excellent dimensional stability can be obtained.

Generally used winder may be used in the film winding method, and there are methods for controlling the tension such as a constant torque method, a constant tension method, a taper tension method, and a programmed tension control method in which the internal stress is constant, and those methods may be used appropriately.

Either of a double-sided adhesive tape or a single sided adhesive tape may be used for the adhesion of film (9) to the winding core (core).

The width of the optical film according to the present embodiment after wound in a roll is preferably 1,200-2,500 mm.

In the present embodiment, as for the thickness of the cellulose ester film after dried, the thickness of the final film is preferably 20-150 μm in view of obtaining a thin liquid crystal display. Here, the above “after dried” means that film (9) is dried so that the amount of residual solvent in film (9) is 0.5% by mass or less.

When the thickness of the cellulose ester film after wound in a roll is too small, the strength necessary for the polarizing plate protective film may not be obtained. When the thickness is too large, the advantage of the thin film compared to the conventional cellulose ester film is lost. The layer thickness is suitably controlled to desired thickness by controlling the dope concentration, the transporting amount of the solution through the pump, the slit space of the mouth metal of the die, an extruding pressure through the die or the speed of the metal support. The thickness is preferably controlled using a layer thickness detecting means for feedbacking the programmed data to the above various devices.

In the course of from just after the casting to the drying in the solution casting method, the atmosphere of the production equipment may be air, or may be an inert gas such as nitrogen gas or carbon dioxide gas. Danger of exceeding the explosion limit concentration of the evaporated solvent in the drying atmosphere must be naturally taken into consideration.

In the present embodiment, the water content the cellulose ester film is preferably 0.1 to 5%, more preferably 0.3 to 4% and further more preferably 0.5 to 2%.

In the present embodiment, the light transmittance of the cellulose ester film is preferably 90% or more, more preferably 92% or more and further more preferably 93% or more.

The optical film manufactured by the method according to the present embodiment exhibits a haze value of 0.3-2.0 when three of them are laminated. Thus, the optical film according to the present embodiment exhibits notably low haze and optical properties of excellent transparency and excellent flatness.

Haze of the optical film may be measured, for example, according to the method of JIS K-6714 using a haze meter (Type 1001DP: Nihon Denshoku Kogyo Co., Ltd.).

With respect to the cellulose ester film manufactured by the method of manufacturing an optical film according to the present embodiment, the modulus of elasticity in tension in the machine direction (MD direction) is preferably 1,500 MPa-3,500 MPa and the modulus of elasticity in tension in the direction perpendicular to the machine direction (TD direction) is preferably 3,000 MPa-4,500 MPa. The ratio of (Elastic modulus in TD direction)/(Elastic modulus of in MD direction) is preferably 1.40-1.90.

When the ratio of (Elastic modulus in TD direction)/(Elastic modulus of in MD direction) of an optical film is less than 1.40, it is not preferred, because slack in the center portion of a wound roll of the film of which width exceeds 1,650 mm becomes noticeable and blocking of the film at the core of the roll becomes prominent. When the ratio of (Elastic modulus in TD direction)/(Elastic modulus of in MD direction) of an optical film is larger than 1.90, it is not preferred, because the polarizing plate tends to curl when heated and unevenness at the corner of a display becomes noticeable when the polarizing film is installed in a liquid crystal panel because the behaviors of dimensional variation of the polarizing plates of the backlight side and the front side becomes different due to the heat of the backlight.

As a concrete measuring method of the moduli of elasticity in tension in the MD direction and in the TD direction of a film, for example, a method described in JIG K7217 can be cited.

Namely, using a tensile testing machine TG-2KN (produced by Minebea Co. Ltd.), the sample is set at a chucking pressure of 0.25 MPa and a standard line spacing distance of 100±10 mm and is pulled at a tension rate of 100±10 mm/min. Then, based on the tension stress-distortion curve, while setting the elastic modulus calculation starting point to 10N and the end point to 30N, a tangent line between them is extrapolated to find the elastic modulus.

The optical film manufactured by the method according to the present embodiment is preferably used as a material to be used for a liquid crystal display device, and, in more detail, for a polarizing plate protective film. Specifically, as a polarizing plate protective film for which severe conditions are required, the optical film manufactured by the method according to the present embodiment is preferably employed.

By using a polarizing plate protective film composed of the optical film according to the present embodiment, provided can be a polarizing plate exhibiting excellent durability, excellent dimensional stability and optical isotropy as well as a possibility of forming a thin film.

A polarizer film is made of a film capable of being oriented by stretching, such as a conventionally used polyvinyl alcohol film, which is treated with a dichroic dye such as iodine and then longitudinally stretched. Since the polarizer film itself is not fully tough and durable, generally, cellulose ester films which are not anisotropic are bonded to both surfaces of the polarizer film as protective films, whereby a polarizing plate is prepared.

The optical film of the present embodiment may be adhered to the above mentioned polarizing plate as a retardation film, or the optical film manufactured by the method according to the present embodiment may be directly adhered to the polarizer film as a film having both functions of a retardation film and a protective film to prepare a polarizing plate. Any adhering method may be used, but an adhesive containing an aqueous solution of a water soluble polymer may be used. A preferable water-soluble polymer adhesive is an aqueous solution of fully-saponified poly vinyl alcohol. A long polarization plate can be obtained by adhering a long polarizer film which is longitudinally stretched and processed with a dichroic dye and a long retardation film manufactured by the method according to of the present embodiment. It is also possible to fabricate an adhesive type polarizing plate by providing a pressure-sensitive adhesive layer (e.g. acrylic pressure-sensitive adhesive layer) and a releasing sheet on the adhesive layer to one surface or both surfaces of the polarizing plate (so that the polarizing plate may be easily adhered to the surface of a LCD cell by removing the releasing sheet from the laminated polarization plate).

Thus obtained polarization plate can be applied to various display devices. Such a polarizing plate is preferably applied to a VA mode liquid crystal display unit in which liquid crystal molecules are oriented substantially vertically when no voltage is applied as well as a TN mode liquid crystal display unit in which liquid crystal molecules are oriented substantially horizontally and twisted when no voltage is applied.

It is possible to prepare the polarizing plate employing a common method. For example, there is a method in which an optical film or a cellulose ester film, which has undergone alkali saponification, is allowed to adhere, employing an aqueous complete saponification type polyvinyl alcohol solution, to both sides of the polarizer film which is prepared by immersing a polyvinyl alcohol film into an iodine solution and then stretched. Alkali saponification, as described herein, refers to the treatment in which cellulose ester film is immersed into a highly alkali liquid at a relatively high temperature so that wettability to water based adhesives is enhanced and adhesive properties are improved.

Onto the optical film of the present embodiment, it is possible to apply various functional layers such as a hard coat layer, an anti-glaring layer, an antireflection layer, an anti-staining layer, an eclectically conductive layer, an optical anisotropic layer, a liquid crystal layer, an orientation layer, an adhesion layer, or a subbing layer. It is possible to arrange these functional layers, employing methods such as coating, vacuum evaporation, sputtering, plasma CVD, or an atmospheric pressure plasma treatment.

The polarizing plate, prepared as above, is arranged on one surface or both surfaces of a liquid crystal cell, and by employing the above, a liquid crystal display device is prepared.

In the present embodiment, the liquid crystal display device contains a liquid crystal cell in which rod-like liquid crystals are sandwiched by a pair of glass plates, and two polarizing plates which are arranged to sandwich the liquid crystal cell, each polarizing plate being composed of a polarizer film and transparent protective films arranged on both surfaced thereof.

By employing the polarizing plate protective film composed of the optical film according to the present embodiment, it is possible to obtain a polarizing plate which provides excellent durability, excellent dimensional stability and optical isotropy, along with a decrease in thickness. Further, the liquid crystal display device employing such a polarizing plate is capable of maintaining stable display performance over an extended period.

Further, it is also possible to employ the optical film according to the present embodiment as a support of an antireflection film or an optical compensation film.

### EXAMPLES

The present embodiment will now be specifically described with reference to examples, however the present embodiment is not limited thereto.

### (Preparation of Dope)

The following components are placed in a tightly sealed vessel followed by heating, complete dissolution while stirring, and filtration, whereby dope (1a) was prepared. Minute silicon dioxide particles (AEROSIL R972V) were dispersed into methanol and then added.

### (Dope Composition)

| | | |
|---|---|---|
| Cellulose triacetate (at an acetyl | 100 | parts by mass |
| substitution degree of 2.88) | | |
| Triphenyl phosphate | 8 | parts by mass |
| Biphenyl diphenyl phosphate | 4 | parts by mass |
| 5-Chloro-2-(3,5-di-sec-butyl-2- | 1 | part by mass |
| hydroxyphenyl)-2H-benzotriazole | | |
| Methylene chloride | 418 | parts by mass |
| Methanol | 23 | parts by mass |
| AEROSIL R972V | 0.1 | part by mass |

(Metal support)

As the metal support to cast the aforesaid dope (1a), employed was a stainless steel (SUS 316) looped belt which was polished to an ultra-mirror surface. The surface of the metal support was subjected to a surface treatment of the film formation, later described in Examples 1-5 and Comparative Examples 1-3. Prior to casting dope (1a) onto the support, a surface treatment was previously carried out via exposure in film forming zone A in FIG. 1. While the surface treatment for film formation was carried out, the temperature of the metal support was regulated to 10° C.

### Example 1

### Atmospheric Pressure Plasma Treatment

In the condition in which gap (d) between blowing slit (h) and the surface of metal support (s) of atmospheric pressure plasma apparatus (20) was regulated to 2 mm, while conveying metal support (s) below plasma apparatus (20), 0.0005-second plasma exposure treatment was carried out. Since it was difficult to determine such accurate contact time of radicals with metal support (s), plasma exposure time, as described herein, refers to the moving time of a certain point on the surface of metal support (s) when the certain point moves the length corresponding to the aperture width of blowing slit (h) under blowing slot (h). When, for example, the aperture width of blowing slit (h) is 2 mm and the moving rate of metal support (s) is 2 mm/second, the plasma exposure time results in 1 second. Further, the used volume of reactive gas (g) was regulated to 3 m³/minute per meter of the exposure width. At that time, reactive gas (g) employed for atmospheric pressure plasma was composed of only nitrogen. Barometric pressure was regulated to 1.0 atm. Further, with regard to solvent vapor concentration around atmospheric pressure plasma apparatus (20), methylene chloride was 6,500 ppm and methanol was 1,500 ppm, both near the surface of metal support (s).

### Example 2

Example 2 was carried out in the same manner as Example 1, except that the plasma exposure treating time was changed to 0.01 second, while the concentration of methylene chloride and methanol near the surface of metal support (s) prior to entrance to atmospheric pressure plasma apparatus (2) was changed to 6,500 ppm and 1,500 ppm, respectively.

### Example 3

Example 3 was carried out in the same manner as Example 2, except that oxygen of 1% by volume was added to reactive gas (g).

### Example 4

Example 4 was carried out in the same manner as Example 2, except that oxygen of 1% by volume and acetylene of 5% by volume were added to reactive gas (g).

### Example 5

### Excimer UV Treatment

Excimer UV apparatus (30) was employed which incorporated excimer UV lamp (u) of a Xe₂ wavelength of 172 nm at an irradiance of 40 mW/cm² in quartz glass (q). Gap (d2) between the surface of quartz glass (q) and the surface of metal support (s) was regulated to 1 mm, and UV radiation exposure time by above excimer UV apparatus (30) was regulated to 0.3 second. UV radiation exposure time, as described herein, refers to the passing time of a certain point on the surface of metal support (s) in the UV radiation exposed zone, namely below quartz glass (q). When, for example, the length of quartz glass (q) is 100 mm and the moving rate of metal support (s) is 100 mm/second, UV radiation exposure time results in 1 second. Further, with regard to solvent vapor concentration around excimer UV apparatus (30), methylene chloride was 6,500 ppm and methanol was 1,500 ppm, both near the surface of metal support (s).

### Comparative Example 1

In Example 2, immediately prior to the entrance of metal support (s) below atmospheric pressure plasma apparatus (20), slit air at a rate of 100 m/second was blown to the entire surface of metal support (s) from the air knife device. In the neighborhood of the surface of metal support (s) immediately prior to the entrance to atmospheric pressure plasma apparatus (20), the concentration of methylene chloride and methanol was regulated to 11 ppm and 1 ppm, respectively, and in film forming and treating zone A immediately below atmospheric pressure plasma apparatus (20), ambience was made so that almost no solvent vapor existed. In the same conditions as Example 2 other than above, a surface treatment film was prepared.

### Comparative Example 2

In Example 3, the addition ratio of oxygen was increased to 5% by volume.

### Comparative Example 3

In Example 5, immediately prior to the entrance of metal support (s), below excimer UV apparatus (30), slit air at a rate of 100 m/second was blown over the entire surface of metal support (s) from the air knife device. In the neighborhood of the surface of metal support (s) immediately prior to the entrance to excimer UV apparatus (30), the concentration of methylene chloride and methanol was regulated to 11 ppm and 1 ppm, respectively, and in film forming and treating zone A immediately below excimer UV apparatus (30), ambience was made so that almost no solvent vapor existed. In the same conditions as Example 5 other than above, a surface treatment film was prepared.

### Comparative Example 4

The surface of metal support (s) was not subjected to a surface treatment via atmospheric pressure plasma apparatus (20) or excimer UV apparatus (30). After wiping the surface with a cleaning cloth incorporating pure water, cleaning was only carried out by a method in which prior to drying of pure water, wiping was performed, in advance, employing a cleaning cloth incorporating methylene chloride.

Numeric values of the pre-treatment pure water contact angle of Examples 1-5 in Table 1 and Comparative Examples 1-4 in Table 2, both described below, are those which are determined after wiping via the aforesaid cleaning cloth incorporating methylene chloride. Further, post-treatment pure water contact angles in Tables 1 and 2 were determined as follows. Since, in Examples 1-5, dope (1a) was cast onto the surface of metal support (s) after the atmospheric pressure plasma treatment or the excimer UV treatment, in order to determine the contact angle, dope (1a) is not cast. In a state in which neighboring gas concentration is only regulated, a treatment film is formed on the surface of metal support (s), and immediately after that, transportation of metal support (s) is stopped and numeric values are determined.

### (Preparation of Cellulose Ester Film)

By employing aforesaid dope (1a), each of the cellulose ester films at a film thickness of 40 μm was prepared.

Filtered dope (1a) at a temperature of 35° C. was uniformly cast from a coat hanger die, onto metal support (7) at a temperature of 20° C., composed of SUS 316 looped belt, which had been subjected to the surface treatment shown in each of aforesaid Examples 1-5 and Comparative Examples 1-4. Temperature of the airstream to dry web (1b) was kept constant at 30° C., and by changing the conveying rate of metal support (7), drying time of web (1b) on metal support (7) was changed from 60 seconds to 120 seconds, whereby the residual solvent ratio of web (1b) during peeling was changed in the range of 30-120% by mass.

After peeling from metal support (7), in an ambience at 90° C., drying was carried out while being conveyed via rollers. In tenter (12), when the residual solvent ratio reached 10%, stretching was conducted in the lateral direction by a factor of 1.06 in an ambience at 100° C. Thereafter, width holding was released, and while being conveyed via rollers, drying was finished in a drying zone at 125° C., whereby a 40 μm thick cellulose ester film was prepared.

In order to evaluate differences due to the surface treatment shown in aforesaid Examples 1-5 and Comparative Examples 1-4, evaluated were pure water contact angle, peeling tension, fluctuation of crossed Nicol (CNT) transmittance, and the surface staining of metal support (s). Each of the evaluation methods is described below.

(Measurement Method of Pure Water Contact Angle)

Since, during film formation in the Examples and Comparative Examples, it is not possible to determine the contact angle of the surface of metal support (s) after the surface treatment, feeding of dope (1a) to casting die (3) was stopped and metal support (s) was also stopped, whereby the contact angle was determined based on the following method.

By employing contact angle meter PG-X, produced by MATSUBO Corp., static contact angle was determined when 3 mm³ pure water was dropped. Measurements were carried out at 10 different positions and the average value was designated as the evaluation value.

(Determination Method of Lowest Tension Enabling Peeling)

During film formation, tension to peel web (1b) from metal support (s) was gradually decreased by controlling the feed roller arranged downstream of peeling roller (8). When the peeling position of web (1b) from metal support (s) started shifting to the casting die existing direction on the downstream side from peeling roller (8), namely the peeling force exceeded the peeling tension, the resulting value was designated as the lowest peeling tension value which enabled peeling. The feed roller, as described herein, though abbreviated in FIGS. 1 and 2, refers to a conveying roller connected to a drive motor, arranged downstream of peeling roller (8), and it creates tension so that web (1b) is pulled via motor rotation, and peeling tension is controlled via output control of the drive motor.

(Determination Method of Fluctuation of Crossed Nicol (CNT) Transmittance)

By employing a polarizer film measuring device (VAP-7070), produced by JASCO Corp, measurements were carried out at a measurement wavelength of 600 nm at intervals of 50 mm in the lateral direction of film (9) and at intervals of 50 mm in a 300 mm zone in the longitudinal direction. Differences between the average value of all data and the largest value deviated from the average value were herein designated as a fluctuation. The fluctuation of the crossed Nicol (CNT) transmittance is employed as an index of the retardation value, and as fluctuation decreases, the retardation value decreases.

(Evaluation of Staining on Surface of Metal support)

By carrying out film formation over a long period, the surface of metal support (7) is stained due to accumulation of raw material impurities. When the surface of the metal support is stained, the resulting pattern is transferred to the film, resulting in white non-uniform defects. It is possible to observe the aforesaid stain by imaging, via ATM, the minute shape of the film transferred to the surface side in contact with the metal support. In the stained portion, observed are granular adhered material transfer traces of several 100 nm-several μm. The aforesaid adhered material transfer traces are called black spots. At the initiation of film formation and two weeks after film formation, the area of black spots is determined, whereby surface staining on the metal support was evaluated.

(Evaluation Method of Staining on Surface of Metal Support)

As AFM, SCANNING PROBE MICROSCOPE (SPI3800N PROBE STATION, MULTIFUNCTIONAL TYPE UNIT SPA-400), produced by Seiko Instruments Inc., was employed, and a 20 μm square of the surface in contact with metal support (7) of film (9) was imaged, and the ratio of the black spot area to the image area was obtained. The relationship of the black spot area ratio with film quality approximately relates to relationship of the evaluation criteria shown below.

(Evaluation Criteria of Staining on Surface of Metal Support)

Area ratio of less than 0.1%: visually, no milky-white non-uniformity was noted
Area ratio of 0.1-0.3%: when a film was held up while moving, slight white non-uniformity was visually noted

Area ratio of ratio of 0.3-0.5%: weak milky-white non-uniformity was visually noted

Area ratio of at least 0.5%: significant milky-white non-uniformity was visually noted, and the product was at NG level

Measurement results via AFM were evaluated based on the previous criteria.

Based on the following method, polarizing plates were prepared in which each of the optical film, prepared in Examples 1-5, and Comparative Examples 1-4, was employed as a polarizing plate protective film, followed by evaluation.

(Preparation of Polarizer Film)

A 120 μm thick long-roll polyvinyl alcohol film was mono-axially stretched (at a temperature of 110° C. and a stretching factor of 5). The resulting film was immersed in an aqueous solution composed of a ratio of 0.075 g of iodine, 5 g of potassium iodide, and 100 g of water for 60 seconds, and subsequently immersed in an aqueous solution composed of a ratio of 6 g of potassium iodide, 7.5 g of boric acid and 100 g of water at 68° C., followed by water washing and drying, whereby a long-roll polarizer film was prepared.

(Preparation of Polarizing Plate)

Subsequently, according to following Processes 1-5, a polarizer film and an optical film were adhered to each other, whereby a polarizing plate was prepared.

Process 1: The long-roll optical film prepared in Example 1 was immersed in a 2×10³ mol/m³ sodium hydroxide solution at 50° C. for 90 seconds, followed by water washing and drying. An antireflection film is previously arranged on the surface of one side of the optical film prepared in Example 1, and a protective film (prepared by polyethylene terephthalate) capable of being peeled again was adhered to the aforesaid surface for protection.

In the same manner, a long-roll cellulose ester film (employed as a substrate of an optical film) was immersed in a 2×10³ mol/m³ sodium hydroxide solution at 50° C. for 90 seconds, followed by water washing and drying.

Process 2: The aforesaid long-roll polarizer film was immersed in a 2% by mass of solids polyvinyl alcohol adhesive tank for 1-2 seconds.

Process 3: The excessive adhesive, adhered to the polarizer film during Process 2, was lightly removed and the resulting film was sandwiched between the optical film, which had been subjected to an alkali treatment during Process 1, and the cellulose ester film, to achieve a laminated layer state.

Process 4: By employing two rotating rollers, adhesion was carried out at a pressure of 20-30 N/cm² and a rate of about 2 m/minute. The adhesion was carefully carried out so that no air bubbles were incorporated.

Process 5: In a drying machine at 80° C., the sample prepared in Process 4 was subjected to a drying treatment for 2 minutes, whereby the polarizing plate of Example 1 was prepared.

In the same manner, by employing long-roll optical films prepared in Examples 2-5 and Comparative Examples 1-4, prepared were polarizing plates of Examples 2-5 and polarizing plates of Comparative Examples 1-4 of the present embodiment.

(Preparation of Liquid Crystal Display Panel)

The polarizing plate on the uppermost surface of a commercial liquid crystal panel (color liquid crystal display, MULTISYNC, LCD1525J, type name LA-1529HM, produced by NEC Corp.) was carefully peeled apart and each of aforesaid polarizing plates of Examples 1-5 and polarize plates of Comparative Examples 1-4 was adhered while matching the polarizing direction, whereby liquid crystal display panels were prepared.

(Visual Evaluation of Polarizing Plate)

Each of the liquid crystal display panels, prepared as above, was visually evaluated by several evaluating persons, while whitish non-uniformity was observed from the front and obliquely.

(Visual Evaluation Criteria of Polarizing Plate)
A: no evaluating persons noticed non-uniformity
B: some evaluating persons noticed slight non-uniformity, which was within the commercially available level
C: many evaluating persons noticed non-uniformity, though it was slight

Evaluation was carried out based on the above criteria.

As evaluation of the pure water contact angle, peeling tension, fluctuation of the crossed Nicol transmittance, and staining on the surfaces of the metal support, each of the results of the area ratio of black spots and visual evaluation of polarizing plates is shown in Table 1 with regard to results of Examples 1-5 and Table 2 with regard to results of Comparative Example 1-4.

TABLE 1

| | | | | | | | Lowest | | | | | |
|---|---|---|---|---|---|---|---|---|---|---|---|---|
| | | | | | | | Tension | | | | | |
| | | | | | | | to Enable | | | Area Ratio of | | |
| | | | | | | | Peeling | | | Black Spots | | |
| | | | Plasma | | | | (N/m width) | | | (%) | | |
| | Pure Water | | Reactive | | | Peeling | | 24 Hours | | | 2 Weeks | Visual |
| | Contact Angle | | Gas | | | Residual | | After | | | After | Evaluation |
| | (°) | | (mixing | | Exposure | Solvent | | Initiation | | | Initiation | of |
| | Before | After | ratio in | | Time | (% by | | of Film | | | of Film | Polarizing |
| | Treatment | Treatment | volume %) | *1 | (seconds) | mass) | *4 | Formation | *2 | *4 | Formation | Plate |
| Example 1 | 66 | 12 | nitrogen | ** | 0.0005 | 30 | 5.5 | 5.7 | 30 | 0 | 0 | A |
| | | | (100) | | | 60 | 6.1 | 6.2 | 30 | 0 | 0 | A |
| | | | | | | 90 | 6.0 | 6.1 | 30 | 0 | 0 | A |
| | | | | | | 120 | 5.7 | 5.8 | 40 | 0 | 0 | A |
| Example 2 | 66 | 8 | nitrogen | ** | 0.01 | 30 | 4.7 | 4.8 | 10 | 0 | 0 | A |
| | | | (100) | | | 60 | 4.9 | 5.0 | 20 | 0 | 0 | A |
| | | | | | | 90 | 4.9 | 5.0 | 20 | 0 | 0 | A |
| | | | | | | 120 | 4.5 | 4.6 | 10 | 0 | 0 | A |
| Example 3 | 67 | 18 | nitrogen/ | ** | 0.01 | 30 | 6.1 | 6.6 | 30 | 0 | 0 | A |
| | | | oxygen | | | 60 | 7.3 | 8.0 | 30 | 0 | 0 | A |
| | | | (99.0/1.0) | | | 90 | 7.7 | 8.4 | 40 | 0 | 0 | A |
| | | | | | | 120 | 6.9 | 7.4 | 30 | 0 | 0 | A |
| Example 4 | 66 | 11 | *3 | ** | 0.01 | 30 | 5.1 | 5.3 | 20 | 0 | 0 | A |
| | | | | | | 60 | 8.1 | 8.2 | 20 | 0 | 0 | A |
| | | | | | | 90 | 8.3 | 8.5 | 30 | 0 | 0 | A |
| | | | | | | 120 | 7.8 | 8.1 | 20 | 0 | 0 | A |
| Example 5 | 66 | 14 | — | methylene | 0.3 | 30 | 6.4 | 6.5 | 30 | 0 | 0 | A |
| | | | | chloride | | 60 | 7.8 | 8.0 | 30 | 0 | 0 | A |
| | | | | 7,500 ppm | | 90 | 8.0 | 8.1 | 30 | 0 | 0 | A |
| | | | | menthol | | 120 | 7.8 | 8.0 | 40 | 0 | 0 | A |
| | | | | 1,500 ppm | | | | | | | | |

*1: ambient gas and concentration thereof near the surface of metal support immediately prior to surface treatment,
*2: fluctuation (×10⁻⁵) of CNT transmittance (%)
*3: nitrogen/oxygen/acetylene (94.0/1.0/5.0),
*4: At Initiation of Film Formation
**: methylene chloride 6,500 ppm menthol 1,500 ppm

TABLE 2

| | | | | | | | Lowest Tension | | | | | |
|---|---|---|---|---|---|---|---|---|---|---|---|---|
| | | | | | | | to Enable | | | Area Ratio of | | |
| | | | | | | | Peeling | | | Black Spots | | |
| | | | Plasma | | | | (N/m width) | | | (%) | | |
| | Pure Water | | Reactive | | | Peeling | | 24 Hours | | | 2 Weeks | Visual |
| | Contact Angle | | Gas | | | Residual | | After | | | After | Evaluation |
| | (°) | | (mixing | | Exposure | Solvent | | Initiation | | | Initiation | of |
| | Before | After | ratio in | | Time | (% by | | of Film | | | of Film | Polarizing |
| | Treatment | Treatment | volume %) | *1 | (seconds) | mass) | *4 | Formation | *2 | *4 | Formation | Plate |
| Comp. 1 | 65 | 43 | nitrogen | *3 | 0.01 | 30 | 5.5 | 8.5 | 80 | 0 | 0.6 | B |
| | | | (100) | | | 60 | 7.3 | 20.1 | 120 | 0 | 1.1 | C |
| | | | | | | 90 | 12.4 | 20.4 | 140 | 0 | 1.1 | C |
| | | | | | | 120 | 12.7 | 22.3 | 110 | 0 | 0.9 | B |
| Comp. 2 | 66 | 53 | nitrogen/oxygen | methylene | 0.01 | 30 | 6.7 | 9.9 | 100 | 0 | 0.9 | C |
| | | | (95.0/5.0) | chloride | | 60 | 8.9 | 15.4 | 160 | 0 | 2.2 | C |
| | | | | 6,500 ppm | | 90 | 16.7 | 22.3 | 180 | 0 | 3.2 | C |
| | | | | menthol | | 120 | 14.4 | 18.9 | 130 | 0 | 1.8 | C |
| | | | | 1500 ppm | | | | | | | | |
| Comp. 3 | 65 | 48 | — | *3 | 0.3 | 30 | 6.6 | 9.8 | 80 | 0 | 0.8 | B |
| | | | | | | 60 | 7.7 | 18.9 | 120 | 0 | 1.2 | C |
| | | | | | | 90 | 12.1 | 19.8 | 140 | 0 | 1.0 | B |
| | | | | | | 120 | 13.1 | 21.2 | 110 | 0 | 0.9 | B |
| Comp. 4 | 66 | — | — | — | — | 30 | 5.9 | 15.1 | 80 | 0 | 0.8 | B |
| | | | | | | 60 | 7.4 | 30.6 | 120 | 0 | 1.3 | C |
| | | | | | | 90 | 11.8 | 25.7 | 140 | 0 | 1.0 | C |
| | | | | | | 120 | 12.7 | 23.2 | 110 | 0 | 1.0 | C |

*1: ambient gas and concentration thereof near the surface of metal support immediately prior to surface treatment,
*2: fluctuation (×10⁻⁵) of CNT transmittance (%),
*3: methylene chloride 11 ppm menthol 1 ppm,
*4: At Initiation of Film Formation,
Comp.: Comparative Example

Based on the results in above Table 1, as shown in Examples 1-5, when, prior to film formation, a surface treatment film is formed on the surface of metal support via the atmospheric pressure plasma treatment or the UV excimer treatment in the presence of solvent vapor, the surface state of the metal support is changed to one in which a significant decrease in the pure water contact angle is noticed. When a dope is cast onto the surface of the metal support after formation of the surface treatment film, effects are confirmed in which it is possible to eliminate regions which have not been employed as a manufacturing condition at a peeling residual solvent ratio of about 60% by mass due to poor peeling. Further, it is possible to peel the film at a relatively lower tension 24 hours after the initiation of film formation, whereby the region employable as manufacturing conditions are increased. Still further, in the atmospheric pressure plasma, it was discovered that as the oxygen ratio in the reactive gas decreased, astoundingly, the effect resulted in a very high rate region, and without lowering the rate, it was possible to always employ the manufacturing rate without modification. Due to enhancement in mold releasing properties of the cast film from the metal support, variation of the peeling position decreases, to decrease the longitudinal deviation of expansion and contraction in the lateral direction of the film, whereby it has become possible to minimize the fluctuation of the crossed Nicol (CNT) transmittance and to enhance optical performance.

On the other hand, in Comparative Examples 1 and 3, in which in the absence of solvent vapor, the surface of the metal support was subjected to the same treatment, it was noticed that the pure water contact angle which shows the surface state of the metal support resulted in a slight decrease. However, large peeling force was needed 24 hours after the initiation of film formation, and the fluctuation of the crossed Nicol transmittance was not decreased, and no significant difference was noticed from Comparative Example 4 in which the surface of the metal support had not been subjected to the treatment.

Further, as shown in Example 4, prior to film formation, when the surface treatment film was formed via the atmospheric plasma treatment on the surface of the metal support in the presence of a monomer gas, effects similar to Example 2 resulted, and it was possible to peel the film at a relatively lower tension, whereby the region as acceptable manufacturing conditions was widened.

Further, conventionally, it has been necessary to clean the surface of the metal support at intervals of several weeks-several months. However, as shown in Examples 1-5, by applying the surface treatment of the present embodiment to the surface of the metal support, the area ratio of black spots decreased significantly after film formation over two weeks and effects to delay the stain formation on the metal support resulted, whereby it was possible to result in the longer cleaning cycle of the surface of the metal support and to contribute to an enhancement in film productivity.

Further, based on visual evaluation results of polarizing plates in Tables 1 and 2, the liquid crystal display panel employing the polarizing plate prepared via each of the films of Examples 1-5 resulted in less non-uniformity of reflected light and excelled in display performance, compared to the liquid crystal display panels employing the polarizing plate prepared via the film of Comparative Examples 1-4.

As mentioned above, according to the present invention, in the optical film manufacturing method via the solution casting film forming method, it is possible to eliminate the poor peeling region by casting a dope onto the surface of the metal support after forming a surface treatment film on the metal support via the atmospheric pressure plasma treatment or the excimer UV treatment. By employing the above, limits for film manufacturing conditions decrease, while productivity increases. Further, by enhancing film peeling properties, variation of the peeling position in the lateral direction significantly decreases and fluctuation of retardation values significantly decreases, whereby it is possible to manufacture an optical film exhibiting optical characteristics of excellent transparency and flatness. Consequently, it is possible to provide a manufacturing method of optical films, optical films, polarizing plates, and display devices, capable of meeting demands for a decrease in film thickness, an increase in width, and quality enhancement of the polarizing plate protective film.

With regard to the manufacturing method of optical films, and the detailed constitution and behavior of each constitution which constitutes optical films, polarizing plates, and display devices according to the present invention, various changes may appropriately be made without departing from the scope of the present invention.

1. A method of manufacturing an optical film comprising the steps of:
casting a resin solution containing a thermoplastic resin, and an additive and a solvent on a surface of a metal support to form a cast film; and
peeling the cast film from the metal support after a part of a the solvent is evaporated,
wherein
the method further comprises the step of forming a surface treatment film via an atmospheric pressure plasma treatment or an excimer UV treatment
on an arbitrary zone on a surface of the metal support, before casting the resin solution on the metal support or
on a zone on a surface of the metal support where the cast film is not carried, while casting the resin solution on the metal support.

2. The method of claim 1, wherein the atmospheric pressure plasma treatment or the excimer UV treatment is carried out by applying plasma or UV light on the metal support under existence of at least a vapor of the solvent to form the surface treatment film on the support.

3. The method of claim 1, wherein the atmospheric pressure plasma treatment or the excimer UV treatment is carried out by applying plasma or UV light on the metal support under existence of one of or both of:
a vapor of the solvent; and
a raw material gas for forming the surface treatment film used for the atmospheric pressure plasma treatment or the excimer UV treatment,
to form the surface treatment film on the support.

4. The method of claim 1, wherein a contact angle between water and the metal support on which the surface treatment film is formed is 5-40°.

5. The method of claim 1, wherein the thermoplastic resin is a cellulose ester resin.

6. The method of claim 1, wherein the metal support is an endless belt, a drum or a roll, each for film formation.

7. The method of claim 1,
wherein a minimum force needed to peel the cast film increases by 0.1-2.0 (N/m) while forming the cast film for 24 hours.

8. An optical film produced by the method of claim 1.

9. The optical film of claim 8, wherein a fluctuation of a transmittance of light at a wavelength of 600 nm of the optical film placed in a crossed Nicol state is 2×10⁻⁵ to 60×10⁻⁵ (%).

10. A polarizing plate having the optical film of claim 8 on at least one surface of the polarizing plate.

11. A display device employing the polarizing plate of claim 10.
